(19) United States
(12) Patent Application Publication
(10) Pub. No.: US 2011/0181987 A1
(43) Pub. Date: Jul. 28, 2011

(54) MAGNETIC RECORDING/REPRODUCTION HEAD

(75) Inventors: Masato Shiimoto, Odawara (JP); Hiroyuki Katada, Odawara (JP); Takeshi Nakagawa, Odawara (JP); Kan Yasui, Kodaira (JP); Yo Sato, Odawara (JP)

(73) Assignee: HITACHI, LTD., Tokyo (JP)

(21) Appl. No.: 12/997,518

(22) PCT Filed: May 19, 2009
(86) PCT No.: PCT/JP2009/059158

§ 371 Date: Mar. 30, 2011

(30) Foreign Application Priority Data
Jun. 10, 2008 (JP) 2008-151224

(51) Int. Cl. G11B 5/39

(52) U.S. Cl. 360/316; G9B/5.114

(57) ABSTRACT

Provided is a differential type reproduction head which can obtain a preferable bit error rate without causing a baseline shift even when two magnetoresistive elements have different maximum resistance change amounts. The differential type reproduction head has a layered structure formed by a first magnetoresistive element having a first free layer, a differential gap layer, and a second magnetoresistive element having a second free layer. When DR₁ and DR₂ are the maximum resistance change amounts of the first magnetoresistive element and the second magnetoresistive element, respectively, HB₁ is a magnetic domain control field applied to the first free layer, and HB₂ is a magnetic domain control field applied to the second free layer, the following relationships are satisfied: HB₁>HB₂ when DR₁>DR₂; HB₂>HB₁ when DR₂>DR₁.

### TECHNICAL FIELD

The present invention relates to a magnetic head mounted on a magnetic recording/reproducing apparatus, and particularly to a magneto-resistive head for reproducing information recorded on a magnetic medium.

### BACKGROUND ART

In recent years, the magnetic recording/reproducing apparatus such as an HDD (Hard Disk Drive) has been required to quickly increase areal density, and the magnetic head and the magnetic media and the like are also required to provide high areal density. The magneto-resistive head mounted on the magnetic recording/reproducing apparatus as the reproducing sensor uses a structure called a spin-valve using the magneto-resistive effect of a multilayer film formed by laminating ferromagnetic metal-layers with a nonmagnetic metal layer sandwiched therebetween. The magneto-resistive effect is a phenomenon in which the electrical resistance varies depending on the angle between the magnetizations of two ferromagnetic layers sandwiching a nonmagnetic intermediate layer. The spin-valve using the magneto-resistive effect has a structure of an antiferromagnetic layer/a ferromagnetic layer/a nonmagnetic intermediate layer/a ferromagnetic layer. This structure provides an output by substantially fixing the magnetization of the ferromagnetic layer contacting the antiferromagnetic layer by an exchange coupling field generated in the interface between the antiferromagnetic layer and the ferromagnetic layer and by freely rotating the magnetization of the other ferromagnetic layer by an external field. The ferromagnetic layer whose magnetization is substantially fixed by the antiferromagnetic layer is called a reference layer. The ferromagnetic layer whose magnetization is rotated by the external field is called a free layer.

Conventionally, for the spin-valve using the magneto-resistive effect, a CIP (Current In the Plane)-GMR (Giant Magneto-Resistive) head used to flow current in the in-plane direction of the laminated film has been adopted. Currently, the CIP-GMR head is being replaced with a TMR (Tunneling Magneto-Resistive) head and a CPP (Current Perpendicular to the Plane)-GMR head used to flow current in the film thickness direction of the laminated film.

There are two major reasons for the replacement of the CIP-GMR head with the TRM head and the CPP-GMR head. The first reason is that the TMR head and CPP-GMR head can increase the read output more than the CIP-GMR head, and thereby can provide high SNR (output/noise ratio). The second reason is that the CPP type of flowing current in the perpendicular direction of the laminated film is more advantageous than the CIP type of flowing current in the in-plane direction of the laminated film in terms of increasing the linear density. The linear density is the bit density in the circumferential direction of magnetic medium. Note that the bit density in the radius direction of the magnetic medium is called a track density. An increase in both the linear density and the track density improves the areal density of the magnetic recording/reproducing apparatus. The increase in the linear density requires improvement in the resolution. The resolution is an index indicating how high the read output can be maintained in high density recording, compared to in low density recording.

Note that the current magneto-resistive head has a structure (so-called shield-type-read head) in which a magneto-resistive film is sandwiched between a lower magnetic shield and an upper magnetic shield. The resolution in the linear density direction depends largely on the gap (Gₛ) between the upper and lower magnetic shields. In other words, the smaller the gap between the upper and lower magnetic shields is, the higher the resolution in the linear density direction is, and thus high areal density can be achieved.

The conventional CIP-GMR head needs to electrically isolate the magneto-resistive film from the upper and lower magnetic shields and thus needs to interpose an insulating film between the upper and lower magnetic shields and the magneto-resistive film respectively. For this reason, it has been difficult to reduce the gap between the upper and lower magnetic shields. On the other hand, the TMR and CPP-GMR heads flowing current in the film thickness direction of the laminated film do not need to interpose an insulating layer between the upper and lower magnetic shields and the magneto-resistive film, which is advantageous in reducing the gap between the upper and lower magnetic shields. For this reason, the magneto-resistive head is shifting from the CIP-GMR head to the TMR and CPP-GMR heads, to increase the output and to improve resolution.

However, it is thought that it is impossible to reduce the film thickness of the CPP type magneto-resistive film to about 30 nm or less, and that the resolution improvement will reach a limit in the near future. The reason is that the film thickness of the above described magneto-resistive film (an antiferromagnetic layer/a ferromagnetic layer/a nonmagnetic intermediate layer/a ferromagnetic layer) has a physical limit of about 30 nm. For this reason, the read head of the current structure imposes a physical limit of about 30 nm on the gap between the upper and lower magnetic shields, which is a major impediment to providing high areal density.

A so-called differential read head has been proposed as means for improving the resolution in the linear density direction. In the in-plane magnetic recording system, a signal field is generated only from a magnetization reversal region with respect to a recorded bit written in a magnetic medium, while in the perpendicular magnetic recording system, a signal field is always generated from each recorded bit. For this reason, the perpendicular magnetic recording system is suitable for use in the differential read head.

Patent Document 1 discloses a read head structure in which a pair of magneto-resistive films is coupled in series with a conductive layer sandwiched therebetween for differential operation in a magnetic recording/reproducing apparatus using the perpendicular magnetic recording system. The two free layers of the pair of magneto-resistive films are disposed adjacent to and facing each other via the conductive layer to serve as a magnetic sensing unit for sensing a signal field, and the resistance change characteristics of the pair of magneto-resistive films have opposite polarity to the magnetic field in the same direction, which enables differential operation. In this case, the resolution in the linear density direction is more influenced by the inside distance between the free layers than the gap between the upper and lower magnetic shields. Therefore, even if the gap between the upper and lower magnetic shields cannot be reduced, a high resolution in the linear density direction can be obtained by reducing the film thickness of the conductive layer interposed between the pair of magneto-resistive films.

Further, Patent Document 2 discloses a detailed structure of the differential read head in which two free layers have resistance change characteristics of opposite polarity to the magnetic field in the same direction. Furthermore, Patent Document 3 discloses a structure of the read head which provides high resolution without the upper and lower magnetic shields.

### Prior Art Documents

### Patent Document

Patent Document 1: JP 2002-183915 A

Patent Document 2: JP 2003-69109 A

Patent Document 3: JP 2004-227749 A

### Non Patent Document

Non Patent Document 1: H. N. Bertram, Theory of magnetic recording (1994)

### SUMMARY OF THE INVENTION

### Problems to be Solved by the Invention

The differential read head has a problem in that when there is difference between the output characteristics (except the polarity to the magnetic field) of the two magneto-resistive sensors, a base line shift occurs in the waveform. There have been no reports as to how the base line shift affects the read/write characteristics of a magnetic disk apparatus. In light of this, the present inventors studied the effects of the base line shift on the read/write characteristics and have found that the base line shift does not affect the read output, resolution, SNR, or the like, but deteriorates the bit error rate.

Therefore, the differential head needs to control the output of the two magneto-resistive sensors as equally as possible. The output of each magneto-resistive sensor is in proportion to the product of the utilization e, the maximum resistance change DR, and the sense current Is. Here, the utilization is defined as dR/DR which is a ratio between the resistance change amount dR when a medium field is applied to the individual magneto-resistive sensors and the maximum resistance change DR.

When the read head is a CPP-type, the sense current flowing in the individual magneto-resistive sensors is constant. Therefore, the difference between the outputs of the individual magneto-resistive sensors is caused only by the difference between the maximum resistance change of the individual magneto-resistive sensors and the utilization thereof. The utilization can be controlled by changing the magnetic domain control field applied to the individual free layers. A general method of controlling the magnetic domain control field includes adjustment of the film thickness of a magnetic domain control layer provided on both sides in the track width direction of the magneto-resistive sensor and the distance between a magneto-resistive sensor and a magnetic domain control layer.

However, if the distance in the track width direction between the free layer and the magnetic domain control layer and the geometric positional relation in the film thickness direction between the free layer and the hard magnetic layer cannot be made identical, there has been invented a structure including a bias field application layer which sandwiches a laminated structure containing a ferromagnetic layer between nonmagnetic layers and is used for the magneto-resistive sensor to apply a bias field along the track direction. This configuration has a structure in which each magneto-resistive sensor has the same maximum resistance change.

Meanwhile, the maximum resistance change has a problem in that even if a first magneto-resistive film and a second magneto-resistive film are made under the same conditions, a difference in maximum resistance change occurs. The maximum resistance change is sensitive to the smoothness of the film thickness of each magneto-resistive sensor, the crystal orientation of the underlying film, and other conditions. Regarding the smoothness of the film thickness, the first magneto-resistive sensor to be made first tends to be better than the second magneto-resistive sensor. Thus, the maximum resistance change of the first magneto-resistive sensor is often larger than the maximum resistance change of the second magneto-resistive sensor. However, when the second magneto-resistive film has a good underlying orientation, the maximum resistance change of the second magneto-resistive sensor tends to be larger than the maximum resistance change of the first magneto-resistive sensor. The underlying layer of the second magneto-resistive film corresponds to an intermediate layer between the first magneto-resistive film and the second magneto-resistive film and has a relatively thick film thickness of several 10 nm. For this reason, the second magneto-resistive film is likely to have a good orientation. Note that there is a possibility that the maximum resistance change of the individual magneto-resistive sensors can be substantially equal by independently adjusting the materials, the film thickness, and like of the free layer, the intermediate layer, and the reference layer. However, if the individual magneto-resistive sensor has a widely different configuration of the free layer, the intermediate layer, and the reference layer, the individual magneto-resistive sensor has a different magnetic characteristic. Thus, it is easy to expect that a problem will occur.

An object of the present invention is to provide a magneto-resistive head which is a differential magneto-resistive head having a high resolution in a linear density direction and provides a good bit error rate without base line shift even if two magneto-resistive sensors have a different maximum resistance change by independently controlling a magnetic domain control field to be applied to the two magneto-resistive sensors.

### Means for Solving the Problems

In order to solve the above problems, a read head according to the present invention has a differential read head having a laminated structure in which a first magneto-resistive sensor having a first free layer, a differential gap layer, a second magneto-resistive sensor having a second free layer are laminated. Further, in order to provide a structure for obtaining a waveform without base line shift, any one of the following two configurations is adopted.

(A) A configuration having a magneto-resistive film and a magnetic control film in which magnetic domain control field HB₁ applied to a first magneto-resistive sensor is larger than magnetic domain control field HB₂ applied to a second magneto-resistive sensor in a differential read head in which maximum resistance change DR₁ of the first magneto-resistive sensor is larger than maximum resistance change DR₂ of the second magneto-resistive sensor.

(B) A configuration having a magneto-resistive film and a magnetic control film in which magnetic domain control field HB₂ applied to the second magneto-resistive sensor is larger than magnetic domain control field HB₁ applied to the first magneto-resistive sensor in a differential read head in which maximum resistance change DR₂ of the second magneto-resistive sensor is larger than maximum resistance change DR₁ of the first magneto-resistive sensor.

Here, a more detailed configuration for achieving (A) will be described below.

1) A configuration in which when a distance between a center in an end portion in a track width direction of a first free layer and a center of a bias film adjacent to the first free layer is set to D₁, a distance between a center in an end portion in a track width direction of a second free layer and a center of a bias film adjacent to the second free layer is set to D₂, a product of saturation magnetization of the first free layer and film thickness thereof is set to Ms₁t₁, and a product of saturation magnetization of the second free layer and film thickness thereof is set to Ms₂t₂, DR₁/DR₂ is equal to or greater than 1.05 and equal to or less than 5.0, Ms₁t₁/Ms₂t₂ is equal to or greater than 0.25 and equal to or less than 4.0, and D₁ is greater than D₂.

2) A configuration in which Ms₁t₁/Ms₂t₂ is equal to or greater than 0.25 and equal to or less than 4.0, DR₁/DR₂ is equal to or greater than 1.05 and equal to or less than 5.0, and the relation between DR₁/DR₂ and HB₁/HB₂ satisfies the following relation.

0.86×(DR₁/DR₂)<(HB₁/HB₂)

3) A configuration in which when the saturation magnetization of a region adjacent to the first free layer is set to MsHB₁, and the saturation magnetization of a region adjacent to the second free layer is set to MsHB₂, DR₁/DR₂ is equal to or greater than 1.05 and equal to or less than 5.0, and DR₁/DR₂, MsHB₂ and HB₁/HB₂ satisfy the following relational expression.

0.8×(DR₁/DR₂)<(MsHB₁/MsHB₂)

Hereinafter, a more detailed configuration for achieving (B) will be described below.

1) A configuration in which when a distance between a center in an end portion in a track width direction of a first free layer and a center of a bias film adjacent to the first free layer is set to D₁, a distance between a center in an end portion in a track width direction of a second free layer and a center of a bias film adjacent to the second free layer is set to D₂, a product of saturation magnetization of the first free layer and film thickness thereof is set to Ms₁t₁, and a product of saturation magnetization of the second free layer and film thickness thereof is set to Ms₂t₂, DR₁/DR₂ is equal to or greater than 0.25 and equal to or less than 0.95, Ms₁t₁/Ms₂t₂ is equal to or greater than 0.25 and equal to or less than 4.0, and D₁ is less than D₂.

2) A configuration in which Ms₁t₁/Ms₂t₂ is equal to or greater than 0.25 and equal to or less than 4.0, DR₁/DR₂ is equal to or greater than 0.25 and equal to or less than 0.95, and the relation between DR₁/DR₂ and HB₁/HB₂ satisfies the following relation.

(HB₁/HB₂)<1.15×(DR₁/DR₂)

3) A configuration in which when the saturation magnetization of a region adjacent to the first free layer is set to MsHB₁, and the saturation magnetization of a region adjacent to the second free layer is set to MsHB₂, DR₁/DR₂ is equal to or greater than 0.25 and equal to or less than 0.95, DR₁/DR₂, MsHB₁ and MsHB₂ satisfy the following relational expression.

(MsHB₁/MsHB₂)<1.2×(DR₁/DR₂)

### Effects of the Invention

According to the present invention, a magnetic read/write head having a differential read head using two magneto-resistive sensors can provide a differential read head without base line shift by controlling a magnetic domain control field applied to the two magneto-resistive sensors. Further, the magnetic recording/reproducing apparatus can achieve a high linear density and a good bit error rate by mounting a magnetic read/write head combining such differential read head and write head on the magnetic recording/reproducing apparatus.

### BRIEF DESCRIPTION OF THE DRAWINGS

FIG. 1 is a schematic diagram of a differential read head according to a first embodiment viewed from ABS.

FIG. 2 is a detailed diagram of the differential read head according to the first embodiment viewed from ABS.

FIG. 3 illustrates a base line shift distribution of a head according to a present invention's structure and experiment 1 according to the first embodiment.

FIG. 4 illustrates a waveform of the differential read head according to the first embodiment and waveforms of individual magneto-resistive sensors.

FIG. 5 illustrates a waveform of the differential read head and waveforms of individual magneto-resistive sensors when a base line shift occurs.

FIG. 6 illustrates a relation between the base line shift and S₁/S₂ ratio between the outputs of two magneto-resistive sensors.

FIG. 7 illustrates a range between HB₁/HB₂ and DR₁/DR₂ of the read head of the first embodiment.

FIG. 8 illustrates a relation of e₁/e₂ and 1/(HB₁/HB₂).

FIG. 9 illustrates a range between e₁/e₂ and Ms₁t₁/(Ms₂t₂) under Ms₁t₁>Ms₂.

FIG. 10 illustrates a range between e₁/e₂ and Ms₁t₁/(Ms₂t₂) under Ms₁t₁<Ms₂t₂.

FIG. 11 illustrates a relation of the bit error rate and the base line shift.

FIG. 12 illustrates a relation of the resistance and the external magnetic field of the differential read head when DR₁ is equal to DR₂.

FIG. 13 illustrates a relation of the resistance and the external magnetic field of the differential read head when DR₁ is different from DR₂.

FIG. 14 illustrates a base line shift distribution of a head according to a present invention's structure and experiment 2 according to a second embodiment.

FIG. 15 illustrates a range between HB₁/HB₂ and DR₁/DR₂ according to the second embodiment.

FIG. 16 is a diagram of a differential read head according to a third embodiment viewed from the ABS surface.

FIG. 17 illustrates a relation of D₂/D₁ and DR₁/DR₂ according to the third embodiment.

FIG. 18 is a diagram of a differential read head according to the third embodiment viewed from the ABS surface.

FIG. 19 illustrates a range between tᵣ₂/tᵣ₁ and DR₁/DR₂ according to the third embodiment.

FIG. 20 is a diagram of a differential read head according to a fourth embodiment viewed from the ABS surface.

FIG. 21 illustrates a relation of D₂/D₁ and DR₁/DR₂ according to the fourth embodiment.

FIG. 22 is a diagram of the differential read head according to the fourth embodiment viewed from the ABS surface.

FIG. 23 illustrates a range between tᵣ₂/tᵣ₁ and DR₁/DR₂ according to the fourth embodiment.

FIG. 24 illustrates a range between HB₁/HB₂ and DR₁/DR₂ according to a fifth embodiment.

FIG. 25 illustrates a range between S₁/S₂ so that the base line shift falls within 20%.

FIG. 26 illustrates a range between e₁/e₂ and DR₁/DR₂ according to the fifth embodiment.

FIG. 27 is a diagram of the differential read head according to the fifth embodiment viewed from the ABS surface.

FIG. 28 is a diagram of the differential read head viewed from the ABS surface for additionally describing the present invention's structure.

FIG. 29 illustrates a range between a tan α/a tan β and DR₁/DR₂ according to the fifth embodiment.

FIG. 30 illustrates a relation of HB₁/HB₂ and a tan α/a tan β.

FIG. 31 illustrates a range between HB₁/HB₂ and DR₁/DR₂ according to a sixth embodiment.

FIG. 32 illustrates a range between a tan α/a tan β and DR₁/DR₂ according to the sixth embodiment.

FIG. 33 illustrates a range between HB₁/HB₂ and DR₁/DR₂ under the condition of Ms₁t₁/Ms₂t₂=8 according to a seventh embodiment.

FIG. 34 illustrates a range between HB₁/HB₂ and DR₁/DR₂ under the condition of Ms₁t₁/Ms₂t₂=8 according to an eighth embodiment.

FIG. 35 illustrates a relation of MsHB₁/MsHB₂ and DR₁/DR₂ according to a ninth embodiment.

FIG. 36 illustrates a relation of MsHB₁/MsHB₂ and DR₁/DR₂ according to a tenth embodiment.

FIG. 37 is a diagram of the differential read head according to an eleventh embodiment viewed from the ABS surface.

FIG. 38 illustrates a configuration example of a perpendicular writing/reading separated magnetic head.

FIG. 39 illustrates a configuration example of a magnetic recording/reproducing apparatus.

### MODES FOR CARRYING OUT THE INVENTION

Hereinafter, a read head to which the present invention is applied, and a magnetic head and a magnetic recording apparatus having the same will be described in detail by referring to the drawings.

### First Embodiment

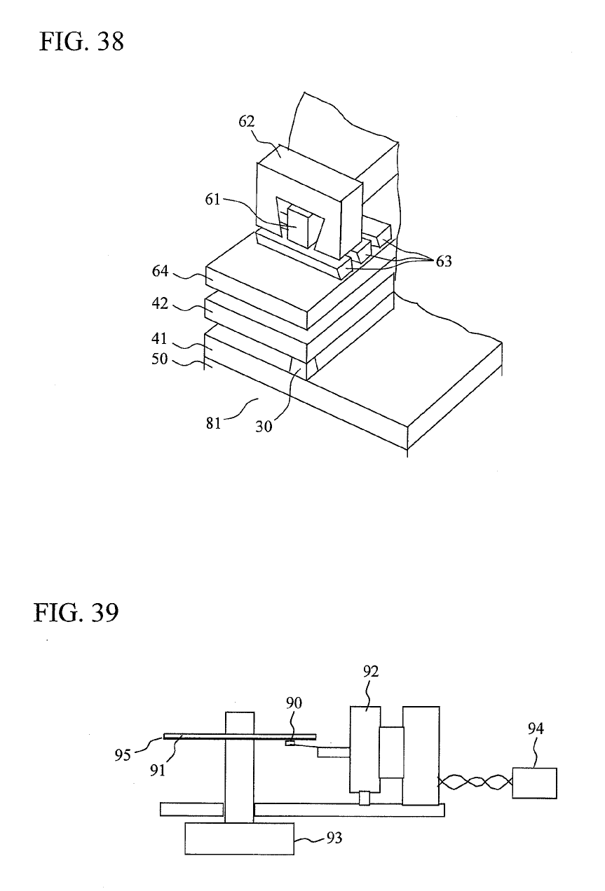

FIG. 38 illustrates a magnetic head including a read head and a perpendicular recording head. On a base 50 serving also as a slider are a lower magnetic shield 41, a magneto-resistive effect laminated film 30, an upper magnetic shield 42, a return pole 64, a coil 63, a main pole 61, and a wraparound shield 62 which is a magnetic shield enclosing the main pole, all of which form an ABS (Air bearing surface) surface 81. The figure illustrates a structure in which the upper magnetic shield and the return pole are provided separately, but a structure in which both the upper magnetic shield and the return pole are integrated is not regarded as a departure from the spirit and scope of the present invention. Further, a structure without the wraparound shield 62 is not regarded as a departure from the spirit and scope of the present invention.

FIG. 39 illustrates a configuration example of a magnetic recording/reproducing apparatus. A disk 91 which holds a recording medium 95 which magnetically records information is rotated by a spindle motor 93 and a head slider 90 is guided on a track of the disk 91 by an actuator 92. More specifically, in a magnetic disk apparatus, a read head and a write head formed on the head slider 90 relatively moves closely to a predetermined recording position on the disk 91 by this mechanism to sequentially write or read a signal. The actuator 92 is preferably a rotary actuator. The record head records a signal on a medium through a signal processing system 94 as the record signal and an output from the read head is obtained as the read signal through the signal processing system 94. Further, when the read head is moved on a desired track, the position on the track is detected using a highly sensitive output from the read head and the head slider can be positioned by controlling the actuator. The figure illustrates one head slider 90 and one disk 91, but a plurality of head sliders and a plurality of disks may be used. Further, the disk 91 may have recording media 95 on both surfaces to record information. When information is recorded on both surfaces of the disk, head sliders 90 are provided on both surfaces.

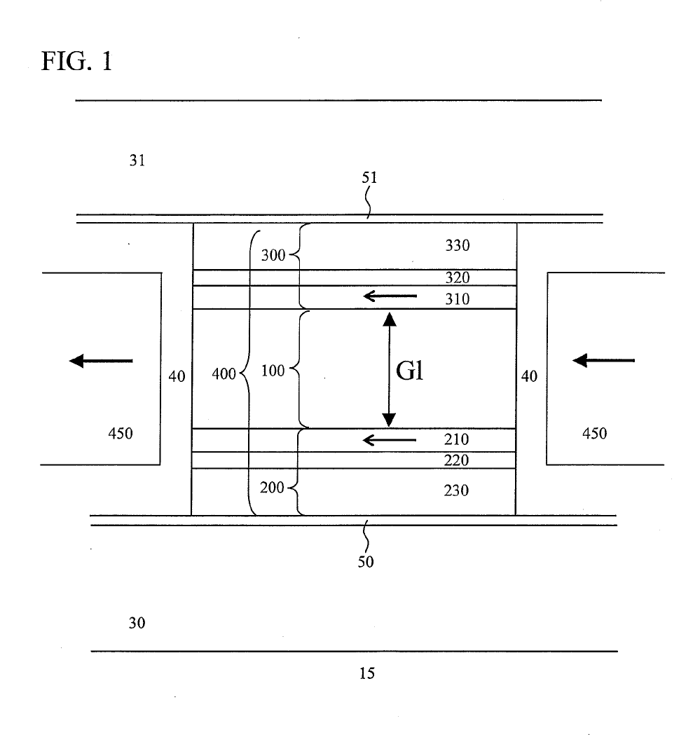

FIG. 1 is a schematic diagram viewed from the ABS surface of a differential read head which is formed in the read head illustrated in FIG. 38. Note that in the figure, the magnetization direction of each ferromagnetic layer is indicated by arrows.

As illustrated in FIG. 1, the differential read head has a laminated structure 400 in which a first magneto-resistive sensor 200, a differential gap layer 100, and a second magneto-resistive sensor 300 are laminated in series from the substrate 15 side. The first and second magneto-resistive sensors 200 and 300 are configured to obtain opposite phase resistance changes with respect to the magnetic field. The first magneto-resistive sensor 200 and the second magneto-resistive sensor 300 of the read head 10 have a first free layer 210 and a second free layer 310 respectively. The distance between the first free layer 210 and the second free layer 310 is defined as G₁. For example, when the first free layer 210 and the second free layer 310 are configured to contact the differential gap layer 100, G₁ is equal to the film thickness of the differential gap layer.

As illustrated in FIG. 1, a hard magnet layer 450 for making the free layers into a single domain can be provided on both sides in the track width direction of the first magneto-resistive sensor 200 and the second magneto-resistive sensor 300. A pair of electrodes for flowing current in the perpendicular direction of the film thickness can be provided on the outside (upper and lower sides) of the two magneto-resistive sensors. One electrode close to the substrate 15 is called a lower electrode 50 and the other electrode far from the substrate 15 is called an upper electrode 51. Instead of the lower and upper electrodes, a conductive ferromagnetic body may be used to serve as both the electrode and the magnetic shield.

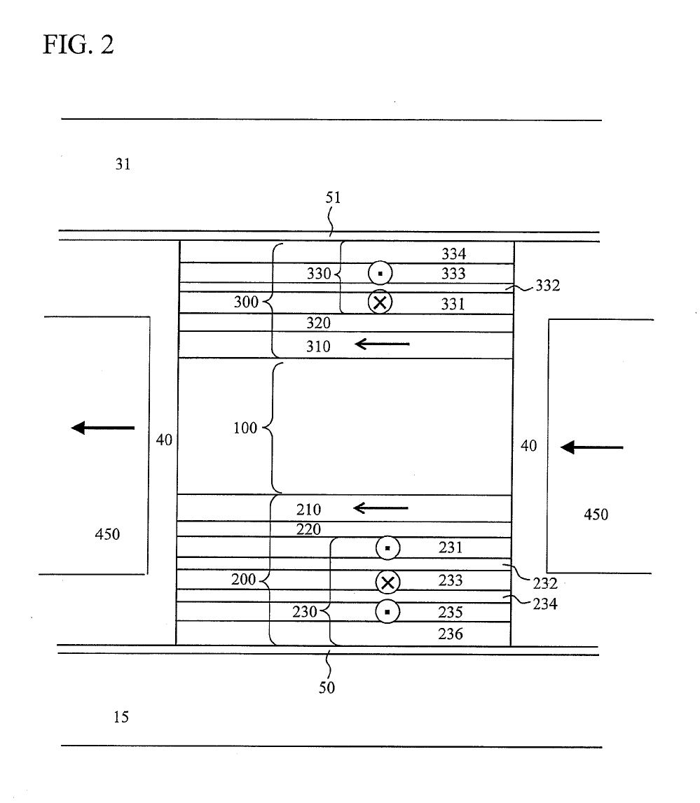

FIG. 2 illustrates a further detailed configuration example of the differential read head 20 viewed from the ABS surface. The structure of the differential gap layer 100 may be a single layer structure or a laminated structure. The basic configuration of the first magneto-resistive film 200 includes the first reference layer 230, the first intermediate layer 220 and the first free layer 210 in that order from the substrate 15 side. Of course, an appropriate underlying layer may be formed on the lowest layer without problem. Likewise, the basic configuration of the second magneto-resistive film 300 includes the second free layer 310, the second intermediate layer 320, and the second reference layer 330 in that order closer to the differential gap layer 100. An appropriate protection layer may be formed on the uppermost layer without problem.

The following description focuses on a configuration example of the first reference layer 230 and the second reference layer 330 so that the first magneto-resistive sensor 200 and the second magneto-resistive sensor 300 exhibit opposite phase resistance changes in the same external magnetic field direction. The first reference layer 230 is a laminated film of the first antiferromagnetic layer 236 and a so-called synthetic ferry structure in which a number m (m: odd number) of ferromagnetic layers and an m−1 number of antiferromagnetic exchange coupling layers are alternately laminated. The second reference layer 330 is a laminated film of the second antiferromagnetic layer 334 and a so-called synthetic ferry structure in which a number n (n: even number) of ferromagnetic layers and an n−1 number of antiferromagnetic exchange coupling layers are alternately laminated. By doing so, the magnetization of the ferromagnetic layers (components of the first reference layer 230 and the second reference layer 330) contacting the first antiferromagnetic layer 236 and the second antiferromagnetic layer 334 is fixed to the same direction. In this case, the magnetization of the ferromagnetic layers (components of the first reference layer 230 and the second reference layer 330) contacting the first intermediate layer 220 and the second intermediate layer 320 substantially contributing to the magneto-resistive effect is fixed to the antiparallel direction. Therefore, the first magneto-resistive film 200 and the second magneto-resistive film 300 exhibit opposite phase resistance change characteristics to the signal fields in the same direction. Note that n may be an odd number and m may be an even number, which is not regarded as a departure from the spirit and scope of the present invention.

Now, the specific composition and film thickness of each component of the differential read head 20 illustrated in FIGS. 1 and 2 will be described. The materials of the substrate 15, the lower magnetic shield 30, the upper magnetic shield 31, and the nonmagnetic intermediate layer 40 are not particularly limited in the present invention and thus generally available materials are given as an example. The material of the substrate 15 may be Al₂O₃—TiC, SiC, or those covered with Al₂O₃. The material of the lower magnetic shield 30 and the upper magnetic shield 31 may be a single layer film of an Ni—Fe alloy and a nitride thereof, Co—Zr or Co—Hf or Co—Ta based amorphous alloy or a multilayer film thereof. The sputtering method or plating method is convenient for film formation. The material of the nonmagnetic intermediate layer 40 may be Al₂O₃, SiO₂, AlN, SiN, or a mixture thereof, or a multilayer film thereof, which can prevent short-circuiting between the lower magnetic shield 30 and the upper magnetic shield 31. The sputtering method is convenient and preferred for film formation.

The sputtering method is preferred for forming the first magneto-resistive film 200/the differential gap layer 100/the second magneto-resistive film 300 from the viewpoint of the controllability of film thickness and alloy composition as well as the mass production efficiency. A preferred configuration example of the first magneto-resistive film 200 is, for example, Ni₈₅Fe₁₅(2)/Co₉₀Fe₁₀(1)/MgO(1)/Co₉₀Fe₁₀(2.5)/Ru(0.45)/Co₉₀Fe₁₀(4)/Ru(0.45)/Co₇₅Fe₂₅(1.5)/Mn₈₀Ir₂₀(6). The numbers in parenthesis indicate the layer thickness in nm. The unit of each alloy composition indicated by the corresponding element suffix is at %. Mn₈₀Ir₂₀(6) corresponds to the first antiferromagnetic layer 236; Co₇₅Fe₂₅(2)/Ru(0.45)/Co₉₀Fe₁₀(2.5)/Ru(0.45)/Co₉₀Fe₁₀(2.5) corresponds to the first reference layer 230; MgO(1) corresponds to the first intermediate layer 220; and Co₉₀Fe₁₀(1)/Ni₈₅Fe₁₅(3) corresponds to the first free layer 210 respectively.

Note that Ta(3)/Ru(2) may be formed as an underlying layer of the first antiferromagnetic layer 236. Note also that here is shown an example of a TMR film using MgO as the first intermediate layer. However, in addition to MgO, an oxide containing Mg, Al, Si, Ti, V, Mn, Zr, Nb, Hf, Ta, and the like, or a nitride thereof, may also be used as the intermediate layer material. When the first intermediate layer is made of Cu, Ag, Au, or an alloy mainly containing such elements, the layer can be used as a CPP-GMR film as it is. Further, the first intermediate layer may be formed as a so-called “current-screen-type” structure in which a conductive path by a metallic pinhole such as Cu is formed in an insulating material such as Al₂O₃.

Likewise, a preferred configuration example of the second magneto-resistive film 300 may be Ni₈₅Fe₁₅(2)/Co₉₀Fe₁₀(1)/MgO(1)/Co₉₀Fe₁₀(2.5)/Ru(0.45)/Co₉₀Fe₁₀(3)/Mn₈₀Ir₂₀(6). A substantially symmetrical configuration of the first magneto-resistive film 200 in terms of the laminating order can provide substantially the same magnetic resistance change characteristics. In order to finely adjust the areal resistance and the magnetic resistance change ratio, mainly the film thickness of the intermediate layer may be appropriately optimized. The only difference is in the configuration of the reference layer. The second reference layer 330 in the second magneto-resistive film 300 is assumed as Co₉₀Fe₁₀(2.5)/Ru(0.45)/Co₉₀Fe₁₀(3). Both are configured as “synthetic ferry” in which a Co—Fe ferromagnetic layer and an Ru layer for antiferromagnetic exchange coupling are alternately laminated. The difference is that the first reference layer 230 in the first magneto-resistive film 200 includes a three-layered Co—Fe layer and the second reference layer 330 in the second magneto-resistive film 300 includes a two-layered Co—Fe layer. More specifically, the first reference layer 230 has a synthetic ferry structure in which a number m (m: odd number) of ferromagnetic layers and an m−1 number of antiferromagnetic exchange coupling layers are alternately laminated. The second reference layer 330 has a synthetic ferry structure in which a number n (n: even number) of ferromagnetic layers and an n−1 number of antiferromagnetic exchange coupling layers are alternately laminated.

By doing so, the magnetization of the ferromagnetic layers (components of the first reference layer 230 and the second reference layer 330) contacting the first antiferromagnetic layer 236 and the second antiferromagnetic layer 334 is fixed to the same direction. In this case, the magnetization of the ferromagnetic layers (components of the first reference layer 230 and the second reference layer 330) contacting the first intermediate layer 220 and the second intermediate layer 320 substantially contributing to the magneto-resistive effect is fixed to the antiparallel direction. Therefore, the first magneto-resistive film 200 and the second magneto-resistive film 300 exhibit opposite phase resistance change characteristics to the signal fields in the same direction, which is suitable for differential operation. Note that m may be an even number and n may be an odd number without causing any hindrance.

The specific composition of the differential gap layer 100 may include Cr, Cu, Pd, Ag, Ir, Pt, Au, Mo, Ru, Rh, Ta, W, Pr, Nd, Sm, Eu, Gd, Tb, Dy, Ho, or Er, or an alloy containing these elements. It should be noted that the material should be selected so as not to generate magneto-resistive effect between the first free layer 210 and the second free layer 310 through the differential gap layer 100. The metals which can be used for the differential gap layer 100 can be classified into the following three major groups: A (Cr, Cu, Pd, Ag, Ir, Pt, Au), B (Mo, Ru, Rh, Ta, W), and C (Pr, Nd, Sm, Eu, Gd, Tb, Dy, Ho, Er). The differential read head using any of the metals of Group A has characteristics that the electrical resistance is lower than the other metals of Group B or C. The metals of Group B have characteristics that the resistance to physical polishing is greater than the other metals of Group A or C. The metals of Group C have characteristics that the spin torque noise caused by spin torque is smaller than the other metals of Group A or B. These elements can be appropriately selected according to the recording density of the magnetic recording/reproducing apparatus, which is the track width of the differential read head, the sensor size such as G₁, and the electrical resistance value thereof.

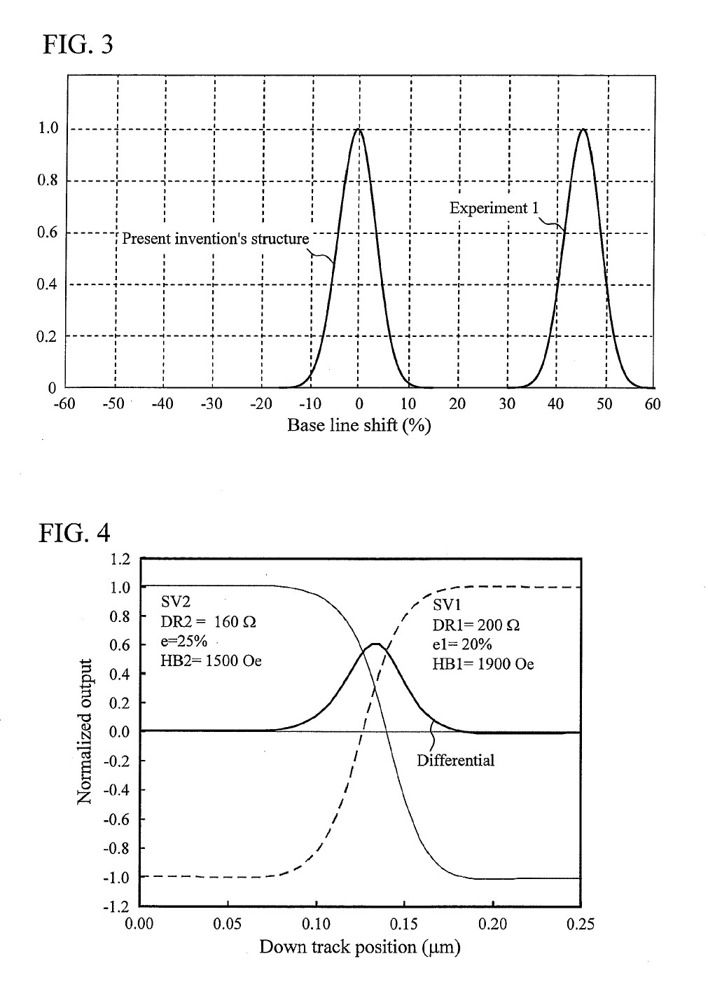

The base line shift reduction effect characterizing the present invention's structure will be described below. FIG. 3 illustrates a base line shift distribution of a plurality of heads of the present invention's structure and a conventional structure. The heads of both the present invention's structure and the conventional structure are made under the same conditions. The base line shift of the present invention's structure is distributed around 0%, while the base line shift of the head (experiment 1) without a structure for controlling the base line shift is distributed around 45%. The change in central value of the base line shift distribution is caused by the base line shift reduction effect characterizing the present invention's structure. The change in base line shift distribution is caused by fabrication errors of the magneto-resistive film and the magnetic domain control film.

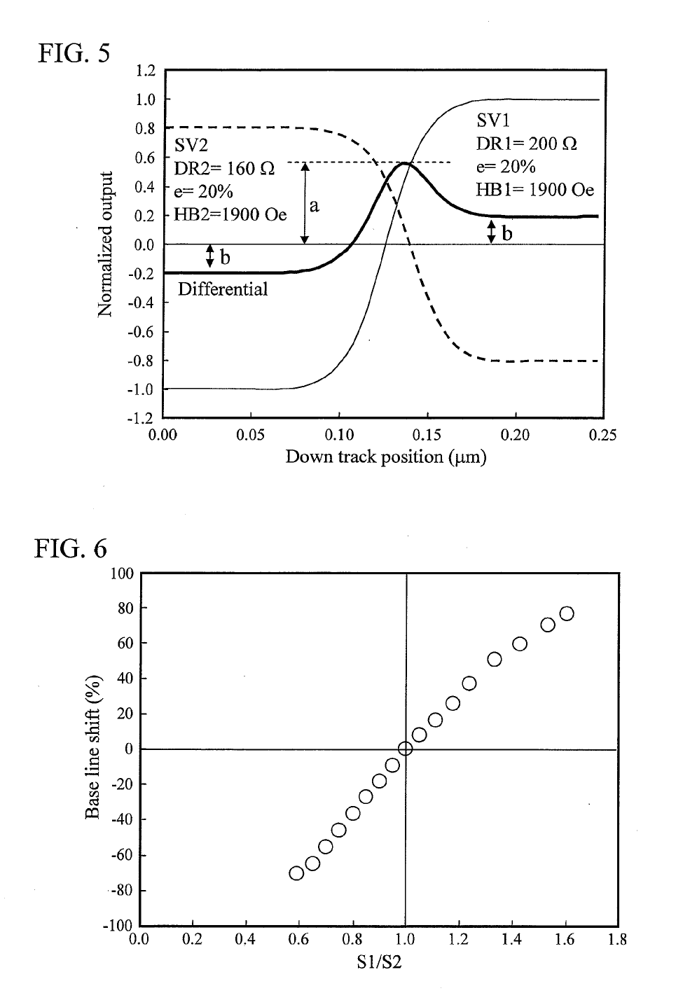

FIG. 4 illustrates a waveform of a head with a base line shift of 0% which is the central value of the base line shift distribution for the head of the present invention's structure. FIG. 5 illustrates a waveform of a head with a base line shift of 45% which is the central value of the base line shift distribution for the differential read head by experiment 1. FIGS. 4 and 5 illustrate not only the waveform of the differential read head but also the waveforms of the two magneto-resistive sensors. The vertical axis of FIGS. 4 and 5 indicates the normalized read output. The outputs of the individual magneto-resistive sensors and the differential read head are normalized so that the output of the first magneto-resistive sensor 200 is 1. The horizontal axis of the figures indicates the position of the medium in the circumferential direction (down track) thereof. As understood from the figures, the differential read head by experiment 1 generates a base line shift, but the waveform of the differential read head of the present invention's structure illustrated in FIG. 4 is a usual pulse waveform without base line shift.

The cause for the base line shift will be described by referring to FIGS. 4 and 5. The read output of the differential read head is a series of the two magneto-resistive sensors, and thus a sum of the outputs of the two magneto-resistive sensors. When the outputs of the two magneto-resistive sensors are equal, the waveform is a usual pulse waveform like the waveform of the differential read head illustrated in FIG. 4. When the outputs of the two magneto-resistive sensors are not equal, a base line shift occurs as illustrated in FIG. 5.

FIG. 6 illustrates a relation between the base line shift and the S₁/S₂ ratio between the output S₁ of the first magneto-resistive sensor 200 and the output S₂ of the second magneto-resistive sensor 300. As understood from FIG. 6, the more the difference between S₁ and S₂, the more the base line shift increases. In other word, the base line shift is caused by the difference between the outputs of the two magneto-resistive sensors.

Now, the description will focus on the cause for the difference between the outputs of the two magneto-resistive sensors and the method of reducing the difference between the outputs characterizing the present invention. The output of the individual magneto-resistive sensors is expressed by the following expression (1).

S_{1,2}=DR_{1,2}×e_{1,2} (1)

Here, S_{1,2} denotes the output of the first and second magneto-resistive sensors 200 and 300. DR_{1,2} denotes the maximum resistance change of the first and second magneto-resistive sensors 200 and 300. e_{1,2} denotes the utilization of the first and second magneto-resistive sensors 200 and 300. The utilization indicates the sensitivity of the individual magneto-resistive sensor to the external magnetic field. The stronger the magnetic domain control field, the smaller the utilization is. In the configuration example of the present invention and the configuration example of the conventional structure illustrated in FIGS. 4 and 5, DR₁ of the differential read head is 20052 and DR₂ thereof is 160Ω. In the configuration example of the conventional structure, both e₁ and e₂ are 20%. As described under “Problems to be Solved by the Invention”, usual differential read heads are likely to cause the difference in DR between the individual magneto-resistive sensors and thus the DR difference occurs.

In order to substantially equalize S₁ and S₂, in the present invention, the present invention's structure controls e₁ and e₂ independently according to the difference between DR₁ and DR₂. In the present configuration example, e₁ is 20% and e₂ is 25%. In general, the base line shift can be reduced using a configuration in which when DR₁ is larger than DR₂, e₁ is smaller than e₂, and when DR₁ is smaller than DR₂, e₁ is larger than e₂. In the present embodiment, DR₁ is larger than DR₂, and thus a configuration is used in which e₁ is smaller than e₂.

In order to make e₁ smaller than e₂, the HB₁/HB₂ ratio between the magnetic domain control field HB₁ applied to the first magneto-resistive sensor 200 and the magnetic domain control field HB₂ applied to the second magneto-resistive sensor 300 satisfies the following expression (2) according to the DR₁/DR₂ ratio between DR₁ and DR₂.

5≧DR₁/DR₂≧1.05 and HB₁>HB₂ (2)

Here, it is assumed that the Ms₁t₁/Ms₂t₂ ratio between the product Ms₁t₁ of the saturation magnetization Ms₁ of the first free layer and the film thickness t₁ and the product Ms₂t₂ of the saturation magnetization MS₂ of the second free layer and the film thickness t₂ is equal to or greater than 0.25 and equal to or less than 4.0. Further, it is assumed that HB₁ and HB₂ are an average value of the magnetic domain control fields in the film surfaces of the free layers. The size of the magnetic domain control field can be calculated by numerical calculation using finite element method from the magnetic domain control layer 450, the geometric shape of the laminated film structure, and the saturation magnetization of the magnetic domain control layer 450.

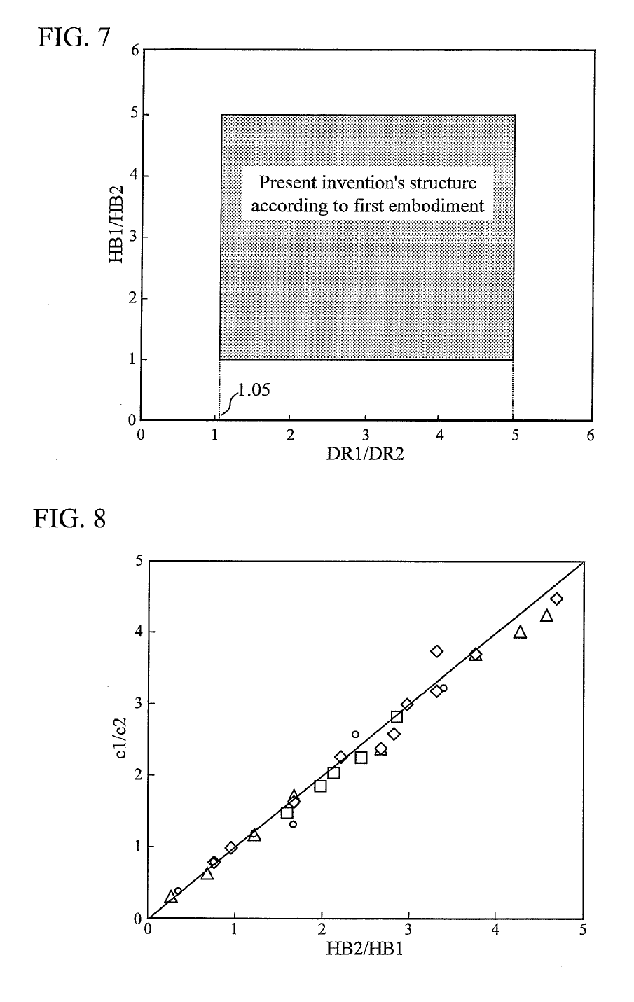

FIG. 7 illustrates a range between DR₁/DR₂ and HB₁/HB₂ according to the present invention. In the range illustrated in FIG. 7, when DR₁ is larger than DR₂, the base line shift can be reduced by making HB₁ larger than HB₂. Note that when DR₁/DR₂ is larger than 1.0 and smaller than 1.05, the magnetic domain control film needs to be controlled so that HB₁/HB₂ is also larger than 1.0 and smaller than 1.05, but it is difficult to suppress the positional errors and the magnetic characteristic variations of the magnetic control film so as to fall within this range. Note also that when DR₁/DR₂ is larger than 4.0, HB₁/HB₂ also needs to be larger than 4.0, but this is difficult because of the shape of the magnetic domain control film and the physical limitation of the material. Therefore, when DR₁/DR₂ is larger than 1.05 and smaller than 5.0, the configuration is made such that HB₁ is larger than HB₂.

The reason why the utilization can be controlled by controlling the magnetic domain control field will be described using the following expression (3) and FIG. 8.

e₁/e₂=HB₂/HB (3)

FIG. 8 illustrates a relation between e₁/e₂ and HB₂/HB₁ evaluated by changing the distance between the magnetic domain control layer 450 of the differential read head and the individual free layers thereof. As understood from FIG. 8, the relation between e₁/e₂ and HB₂/HB₁ satisfies the expression (3). Note that the relation does not depend on the film thickness of the magnetic domain control layer 450, the film thickness of the nonmagnetic intermediate layer interposed between the magnetic domain control layer 450 and the individual free layers, the magnetic shield interval, the track width of the differential read head, or the like.

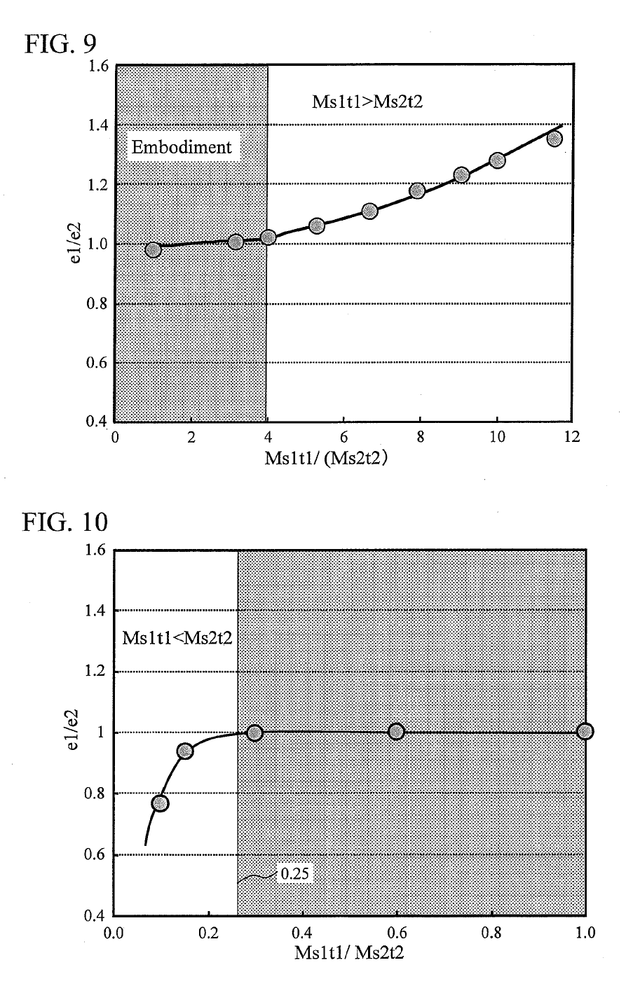

Next, FIG. 9 illustrates a relation between e₁/e₂ and Ms₁t₁/Ms₂t₂ under the condition of Ms₁t₁>Ms₂t₂. FIG. 10 illustrates a relation between eₗ/e₂ and Ms₁t₁/Ms₂t₂ under the condition of Ms₁t₁<Ms₂t₂. As understood from FIGS. 9 and 10, e₁/e₂ hardly depends on Ms₁t₁/Ms₂t₂ under the condition that Ms₁t₁/Ms₂t₂ is equal to or greater than 0.25 and equal to or less than 4.0. Therefore, under the condition that Ms₁t₁/Ms₂t₂ is equal to or greater than 0.25 and equal to or less than 4.0, the base line shift can be reduced simply by controlling the magnetic domain control fields applied to the two free layers.

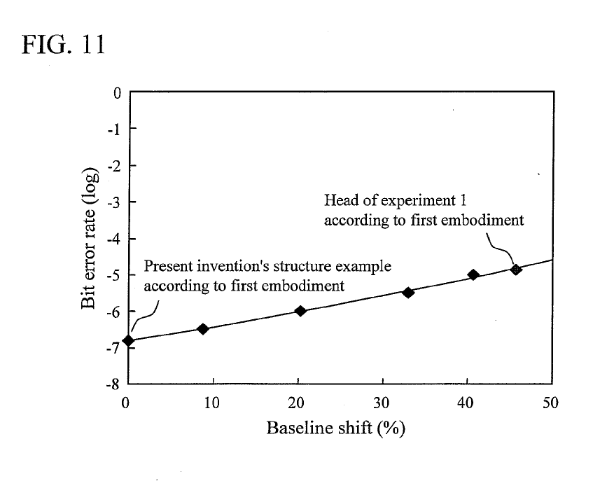

The advantages of the present invention will be described below. FIG. 11 illustrates a relation between the base line shift of the differential read head and the bit error rate thereof. The size of the base line shift is defined using “a” and “b” in FIG. 5 as follows.

Baseline shift=b/a×100 (4)

As understood from FIG. 11, the bit error rate is deteriorated by the base line shift. The better the bit error rate, the higher recording density the magnetic recording/reproducing apparatus can achieve. The present invention's structure can suppress the base line shift, and thus can achieve a good bit error rate and a high recording density as the magnetic recording/reproducing apparatus.

A specific configuration example according to the present invention will be described below. In the configuration example of the present invention illustrated in FIG. 4, as described above, when DR₁ is 200Ω and DR₂ is 160Ω, e₁ is 20% and e₂ is 25%. In addition, Ms₁ and Ms₂ are 10000 Oe; t₁ and t₂ are 3 nm; HB₁ is 1500 Oe; and HB₂ is 1900 Oe. In the present configuration example, DR₁/DR₂ is 1.25 and HB₁/HB₂ is 1.27. From the expression (3), e₁/e₂ is 0.8. From the expression (1), S₁/S₂ is almost equal to 1. Thus, no base line shift occurs and the bit error rate is not deteriorated.

On the contrary, in the configuration example of the conventional structure illustrated in FIG. 5, when DR₁ is 200Ω and DR₂ is 160Ω, both e₁ and e₂ are 20%. Both HB₁ and HB₂ are 1900 Oe. In addition, both Msₗ and Ms₂ are 10000 Oe and both t₁ and t₂ are 3 nm. Therefore, DR₁/DR₂ is 1.25 and HB₁/HB₂ is 1.0. From the expression (3), e₁/e₂ is also 1.0. From the expression (1), S₁/S₂ is 1.25. At this time, a base line shift of about 45% occurs as illustrated in FIG. 6. As understood from FIG. 10, the bit error rate is deteriorated by about two digits. Thus, the present invention's structure can reduce the base line shift and can reduce the deterioration of the bit error rate.

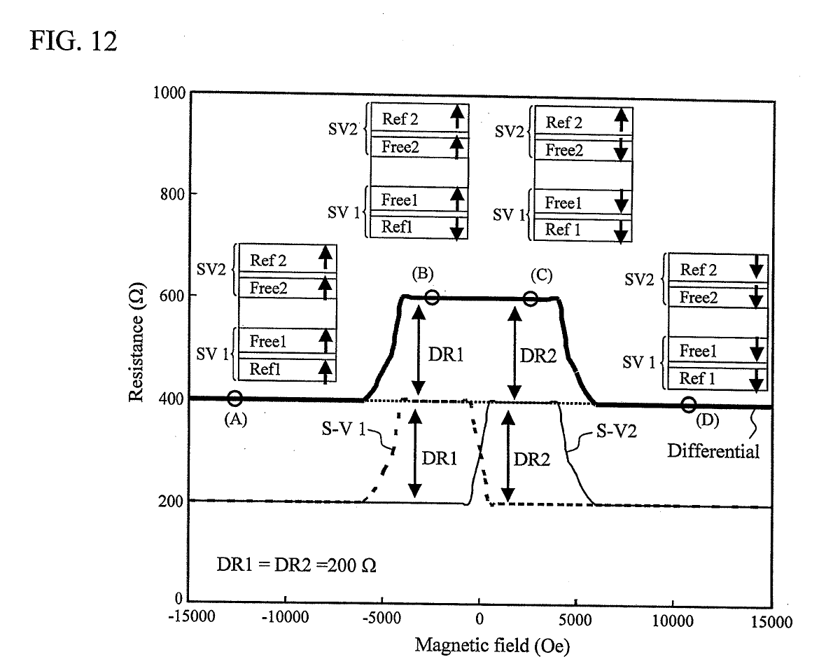

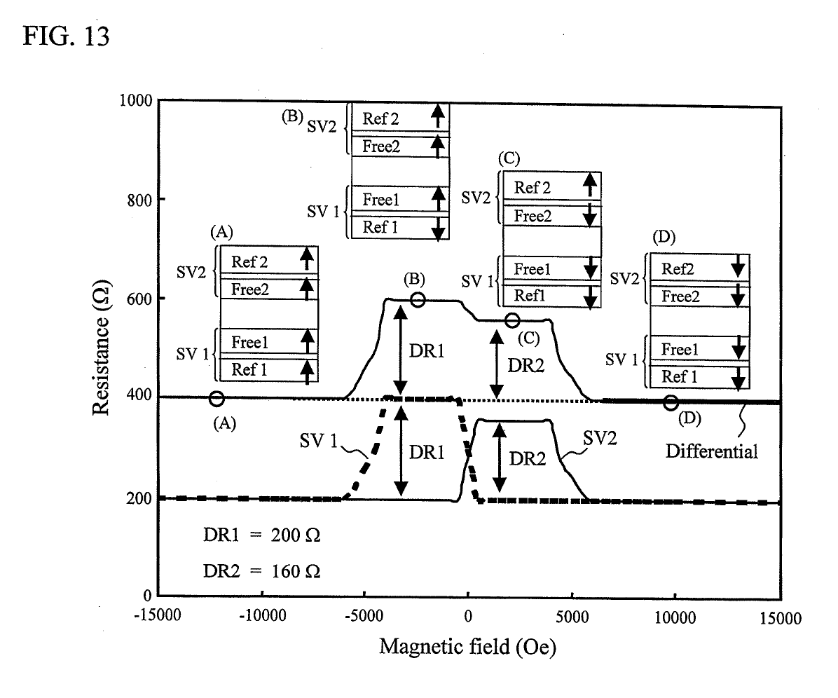

Finally, the description will focus on how the DR difference between the two magneto-resistive sensors is observed in the actual differential read head. FIG. 12 illustrates the dependency of the resistance and the external magnetic field of the differential read head having no DR difference between the two magneto-resistive sensors. FIG. 13 illustrates the dependency of the resistance and the external magnetic field of the actual differential read head having a DR difference between the two magneto-resistive sensors. The external magnetic field is applied in a film in-plane direction perpendicular to the track width direction. Regarding the polarity of the magnetic field, the direction of magnetization of the reference layer of the first magneto-resistive sensor 200 in an initial state is defined as positive. As illustrated in FIGS. 12 and 13, the minimum resistance value of the differential read head is 400Ω. Moreover, the maximum resistance change of the first and second magneto-resistive sensors of the differential read head illustrated in FIG. 12 and the first magneto-resistive sensor of the differential read head illustrated in FIG. 8 is 200Ω. Unlike the above, only the maximum resistance change of the second magneto-resistive sensor 300 of the differential read head illustrated in FIG. 13 is 160Ω. Thus, DR of the individual magneto-resistive sensors can be determined by measuring the relation between the resistance and the magnetic field of the read head.

### Second Embodiment

Another configuration example of the present invention will be described. Unlike the first embodiment, the present configuration example is configured such that DR₁ is smaller than DR₂. One of the reasons that the maximum resistance change of the second magneto-resistive sensor is larger is that the second magneto-resistive film has a good underlying orientation. This is because the underlying film of the second magneto-resistive film corresponds to the intermediate layer between the first magneto-resistive film and the second magneto-resistive film and has a relatively thick film thickness of several 10 nm which tends to have a good orientation.

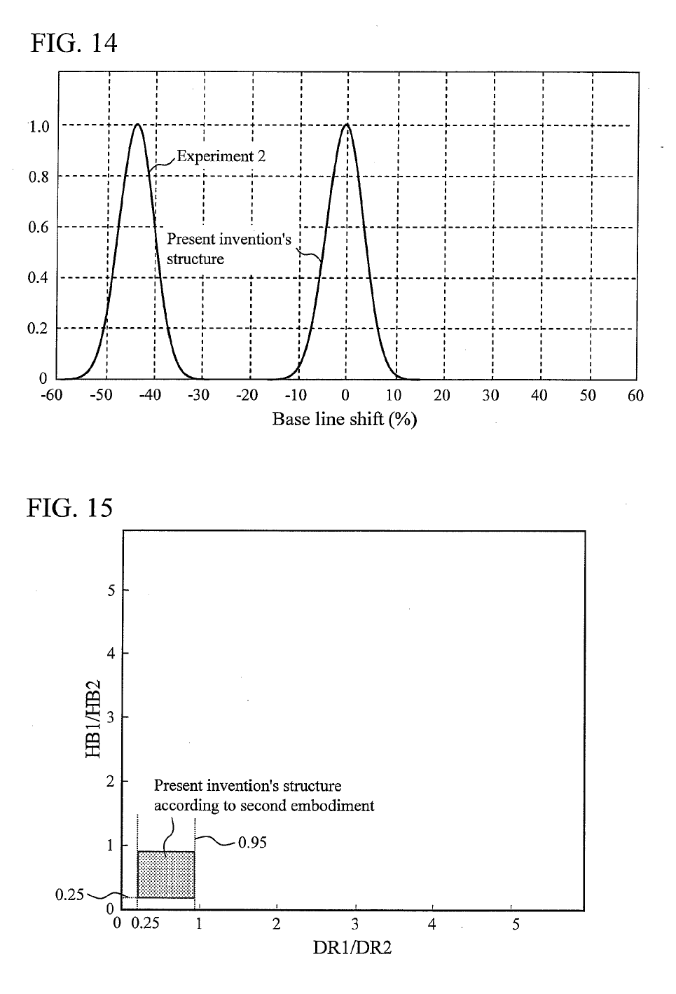

Like the configuration of the first embodiment, the present configuration example can reduce the base line shift caused by the difference between DR₁ and DR₂ by controlling HB₁ and HB₂. FIG. 14 illustrates the base line shift distributions of a plurality of heads to which the present invention is not applied (experiment 2) and a plurality of heads according to the present configuration example. In the experiment 2, the center of the base line shift distribution is −45%, while in the present configuration example, the center thereof is 0%.

A specific structure of the present configuration example for reducing the base line shift will be described below. The present configuration example is the same as the configuration of the first embodiment except for the parameters HB₁ and HB₂, and thus the detailed configuration is omitted. In the present configuration, the positional relation between the magnetic domain control film and the magneto-resistive sensor is adjusted such that HB₁/HB₂ falls within the range illustrated in FIG. 15 according to DR₁ and DR₂. Moreover, the range illustrated in FIG. 15 satisfies the following expression (5).

HB₁<HB₂ under 0.95≧DR₁/DR₂≧0.25 (5)

The reason why DR₁/DR₂ needs to be smaller than 0.95 is that when DR₁/DR₂ is smaller than 1.0 and larger than 0.95, the magnetic domain control film needs to be controlled so that HB₁/HB₂ is also smaller than 1.0 and larger than 0.95, but it is difficult to suppress the positional errors and the magnetic characteristic variations of the magnetic control film so as to fall within this range. Further, when DR₁/DR₂ is smaller than 0.25, HB₁/HB₂ also needs to be smaller than 0.25, but this is difficult because of the shape of the magnetic domain control film and the physical limitation of the material. Therefore, when DR₁/DR₂ is equal to or greater than 0.25 and equal to or less than 0.95, the configuration is made such that HB₂ is larger than HB₁.

### Third Embodiment

Another configuration example of the present invention will be described. Like the first embodiment, the present configuration example can reduce the base line shift in the differential read head in which DR₁ is larger than DR₂. In the third embodiment, a particularly detailed description will be given of the method of controlling the magnetic domain control field of the two magneto-resistive sensors not described in the first embodiment. Regarding the method of controlling the magnetic domain control field, the relative positional relation and the geometric shape of the magnetic domain control layer 450 and the first and second free layers of the differential read head are set. The configuration of the two magneto-resistive sensors and the differential gap layer in the present configuration example is the same as that of the first embodiment, and thus the description duplicating the first embodiment will be omitted. In the present configuration example, in order to control the HB₁/HB₂ ratio of the magnetic domain control fields applied to the two free layers, the distance between the two free layers and the magnetic domain control layer 450 is controlled.

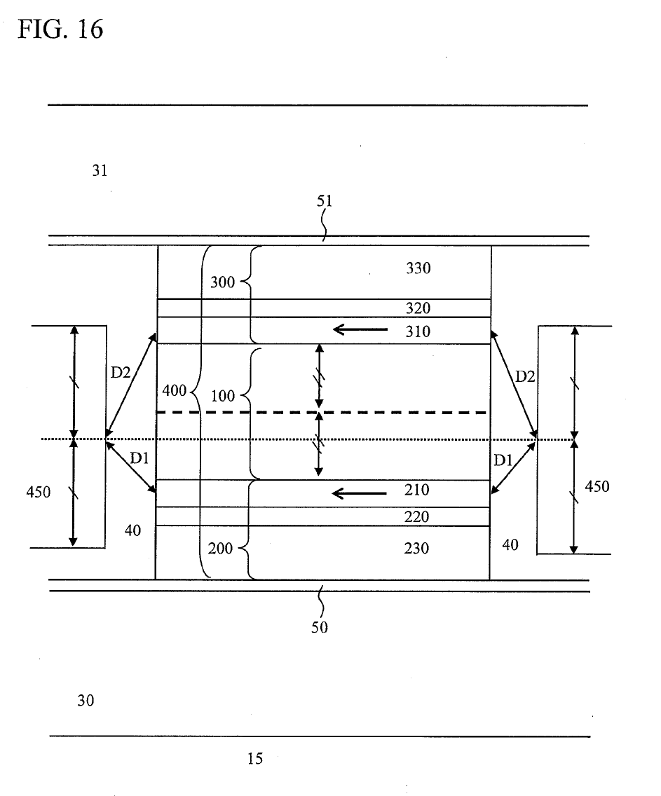

There are two major methods of controlling the distance between the two free layers and the magnetic domain control layer 450. One is a method of offsetting the magnetic domain control layer 450 in the film thickness direction like the configuration example illustrated in FIG. 16. The second one is a method of providing a difference between the film thickness tᵣ₁ of a region adjacent to the first free layer and the film thickness tᵣ₂ of a region adjacent to the second free layer, and the film thickness of the nonmagnetic intermediate layer 40 interposed between the magnetic domain control layer 450 and the laminated film 400. The difference between tᵣ₁ and tᵣ₂ can be provided by controlling the shape of the magnetic domain control layer 450.

First, a configuration example for the first method will be described. FIG. 16 illustrates the first configuration example in the present invention's structure. Specifically, when the distance between the center of an end portion in the film thickness direction of the magnetic domain control layer 450 close to both ends in the track width direction of the laminated film 400 and the center of an end portion in the film thickness direction of the first free layer in the track width direction is set to D₁, and likewise the distance between the center of the magnetic domain control layer 450 and the center of an end portion in the film thickness direction of the second free layer in the track width direction is set to D₂, the shape of the magnetic domain control film and the magneto-resistive sensor is controlled so as to satisfy the following expression (6).

D₁<D₂ (6)

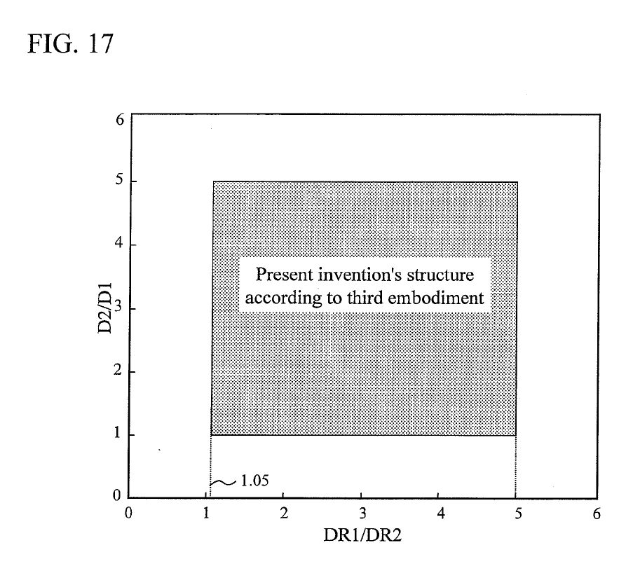

Note that in the present configuration example, DR₁/DR₂ is equal to or greater than 1.05 and equal to or less than 5.0, Ms₁t₁/Ms₂t₂ is equal to or greater than 0.25 and equal to or less than 4.0. The reason for this is the same as described in the first embodiment. The range between DR₁/DR₂ and D₁/D₂ which is a condition of the present configuration is illustrated in FIG. 17.

In the configuration example illustrated in FIG. 16, DR₁ is 200Ω, and DR₂ is 160Ω. On the condition that D₁ and D₂ are equal, e₁ and e₂ are equal; D₁/D₂ is 1.25 and from the expression (1), S₁/S₂ is also 1.25; and thus it is understood from FIG. 6 that a base line shift of about 45% occurs. Meanwhile, in the present configuration example illustrated in FIG. 16, D₁/D₂ is set to 1.4. Specifically, D₁ is 14 nm and D₂ is 10 nm. The difference can be achieved by offsetting the magnetic domain control layer 450 in the lower electrode direction by about 5 nm. M₁ can be 1300 Oe and HB₂ can be 1600 Oe. From the expression (3), e₁ is 24% and e₂ is 29%. DR₁/DR₂ is 1.25 while e₁/e₂ is 1.2; thus from the expression (1), S₁/S₂ can be 1.04; and thus from FIG. 6, the base line shift can be reduced to about 5%.

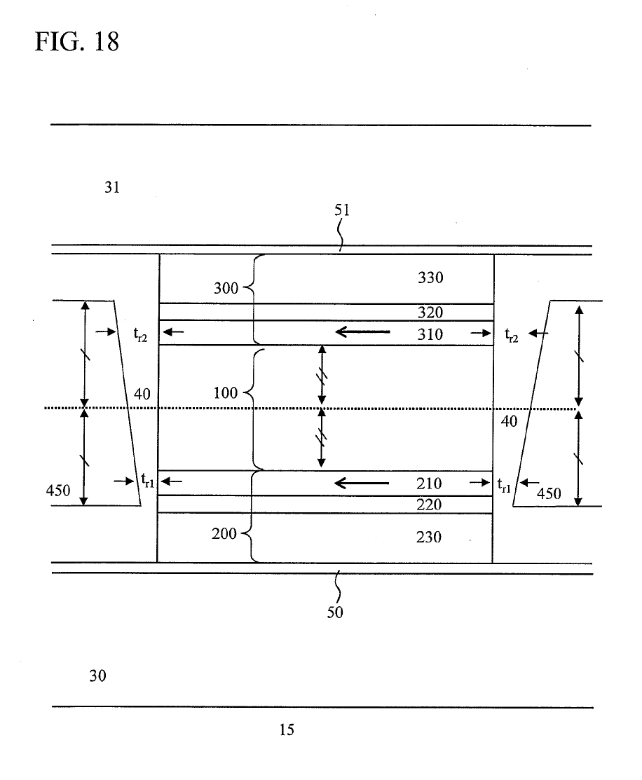

A configuration example for the second method is illustrated in FIG. 18. The present configuration example is different from the configuration example illustrated in FIG. 16 only in that there is no offset of the magnetic domain control layer 450 in the film thickness direction and there is a difference between tᵣ₁ and tᵣ₂. Note that tᵣ₁ and tᵣ₂ satisfy the following expression (7) according to DR₁/DR₂.

tᵣ₁<tᵣ₂ (7)

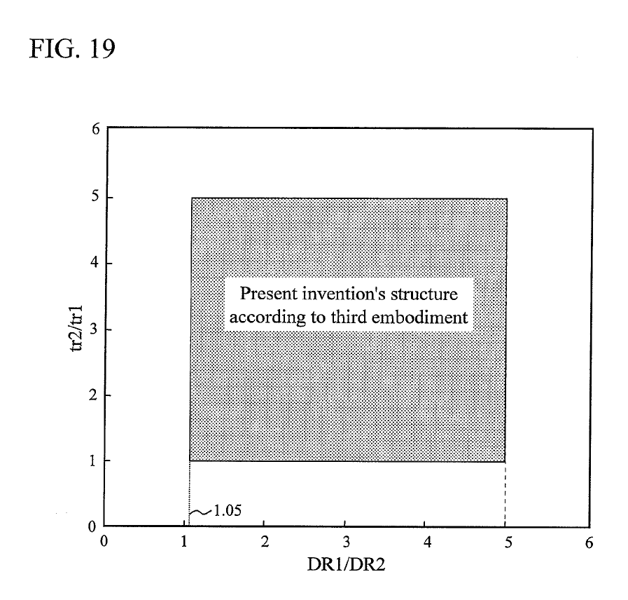

The range between DR₁/DR₂ and tᵣ₁/tᵣ₂ which is a condition of the present configuration is illustrated in FIG. 19. In the present configuration example illustrated in FIG. 16, DR₁ is 200Ω and DR₂ is 160Ω. In addition, tᵣ₁ and tᵣ₂ are 5 nm and 9 nm respectively; HB₁ and HB₂ are 2000 Oe and 1500 Oe respectively; and e₁ and e₂ are 19% and 25% respectively. Accordingly, S₁/S₂ is 0.95 and the base line shift is about −5%.

The first and second structures are the same in that the distance between the magnetic domain control layer 450 and the free layer is controlled. However, from the point of view of the reproduction process, the first structure has an advantage in that it is easier to position and can control HB₁/HB₂ relatively accurately. Meanwhile, the second structure has an advantage in that it can increase the difference between HB₁ and HB₂ more than the first structure. This is because the dependency of the distance between the magnetic domain control layer 450 and the free layer is stronger than that of the offset of the magnetic domain control layer 450. Thus, it is preferable that when the difference between DR₁ and DR₂ is small, the first method is used and when the difference between DR₁ and DR₂ is large, the second method is used.

### Fourth Embodiment

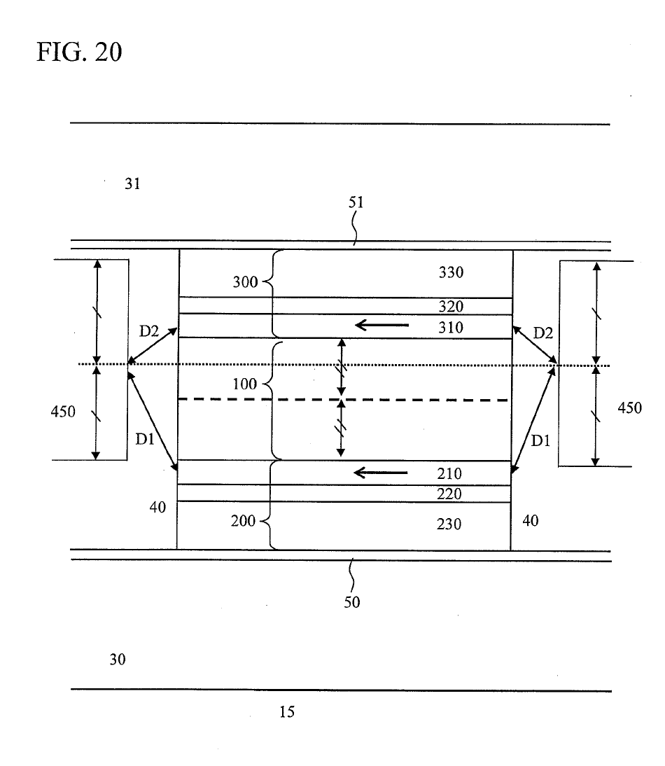

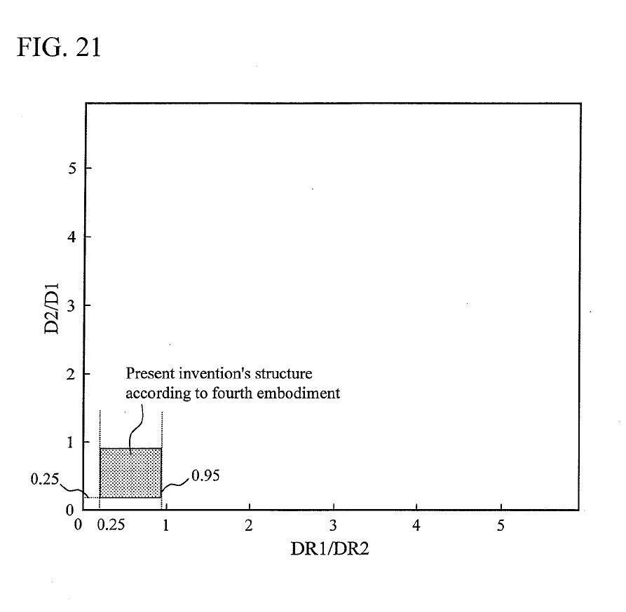

Another configuration example of the present invention will be described. The present configuration example is used when DR₁ is smaller than DR₂. Like the configuration of the third embodiment, the present configuration example controls the shape of the magnetic domain control film and the magneto-resistive sensor to reduce the base line shift caused by the difference between DR₁ and DR₂ by controlling HB₁ and HB₂. FIG. 20 illustrates a differential read head according to the present configuration. The present configuration example is the same as the configuration of the third embodiment except for the parameters HB₁ and HB₂, and thus the detailed description of the configuration is omitted. The present configuration adjusts the positional relation and the like between the magnetic domain control film and the magneto-resistive sensor so that D₂/D₁ falls within the range illustrated in FIG. 21 according to DR₁ and DR₂. The range illustrated in FIG. 21 satisfies the following expression (8).

D₁>D₂ (8)

Note that in the present configuration example, DR₁/DR₂ is equal to or greater than 0.25 and equal to or less than 0.95 and Ms₁t₁/Ms₂t₂ is equal to or greater than 0.25 and equal to or less than 4.0. The reason for this is the same as described in the second embodiment. The present configuration can reduce the base line shift by controlling the positional relation between the magnetic domain control film and the magneto-resistive sensor.

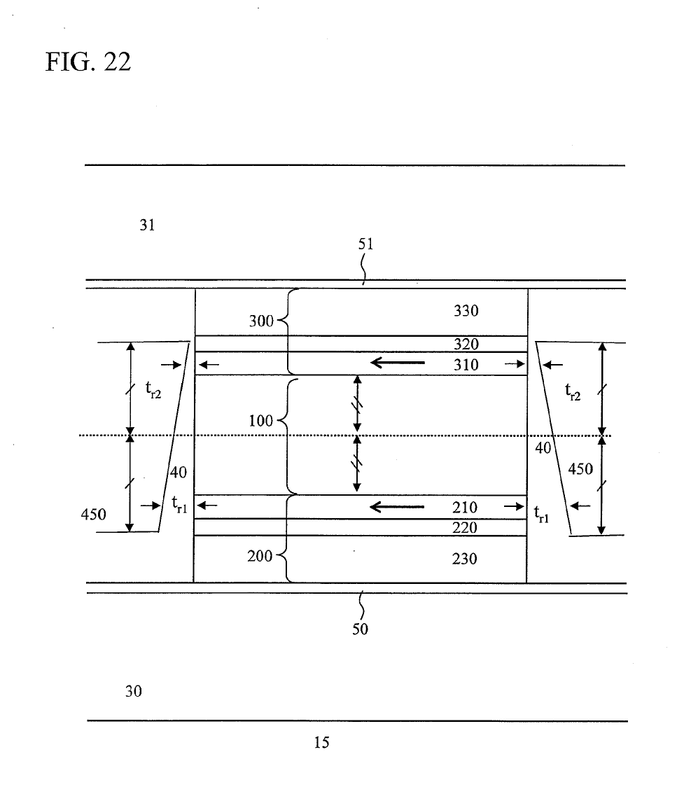

There are two major methods of controlling the distance between the two free layers and the magnetic domain control layer 450. One is a method of offsetting the magnetic domain control layer 450 in the film thickness direction like the configuration example illustrated in FIG. 20. The second one is a method of providing a difference between the film thickness tᵣ₁ of a region adjacent to the first free layer and the film thickness tᵣ₂ of a region adjacent to the second free layer, and the film thickness of the nonmagnetic intermediate layer 40 interposed between the magnetic domain control layer 450 and the laminated film 400. The difference between tᵣ₁ and tᵣ₂ can be provided by controlling the shape of the magnetic domain control layer 450. A specific configuration for the second method is illustrated in FIG. 22. The present configuration example illustrated in FIG. 22 is configured such that tᵣ₁ and tₜ₂ satisfy the following expression (9) according to DR₁/DR₂.

tᵣ₁>tᵣ₂ (9)

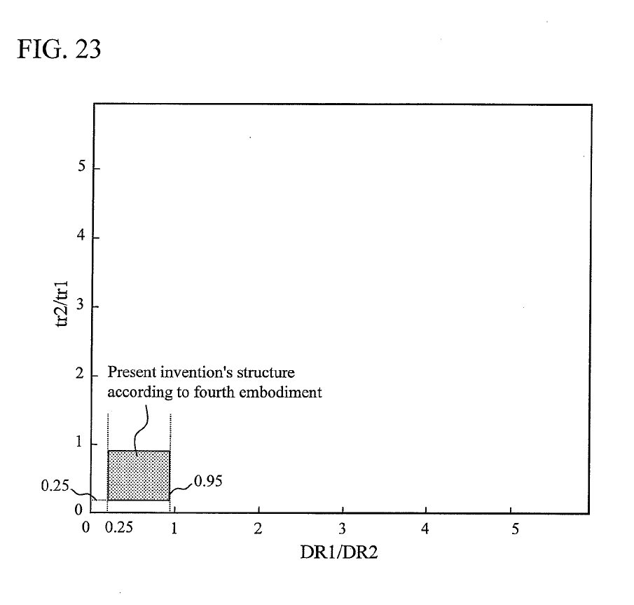

From the expression (9), tᵣ₁ and tₜ₂ fall in the range illustrated in FIG. 23 according to DR₁/DR₂. The above configuration can reduce the base line shift in such a manner that even if DR₁ is smaller than DR₂, D₁ is made larger than D₂ or tᵣ₁ is made larger than tᵣ₂.

### Fifth Embodiment

Another configuration example of the present invention will be described below. The configuration example of a differential read head according to the fifth embodiment modifies the configuration example in the first embodiment or the third embodiment in such a manner that the range of HB₁/HB₂ is particularly made appropriate so that the size of the base line shift fall within 20%. In the fifth embodiment, the configuration of the two magneto-resistive sensors, the differential gap layer, and the magnetic domain control layer 450 is the same as described in the first embodiment, and thus the description is omitted.

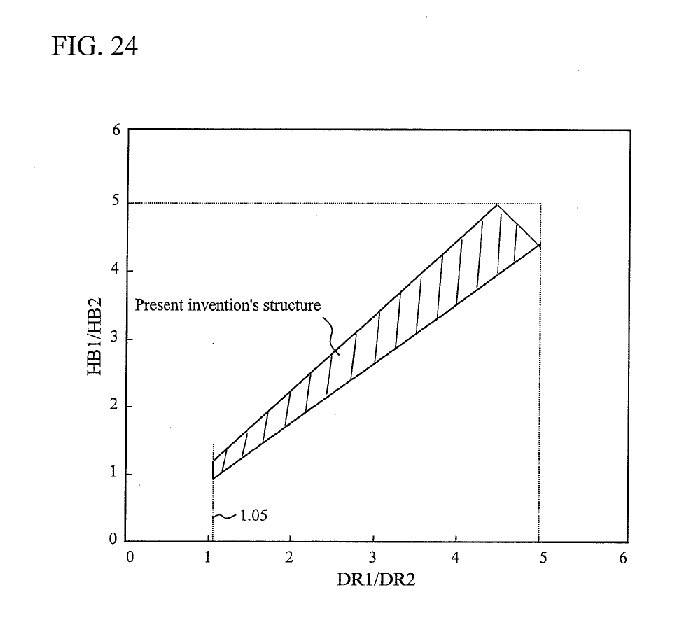

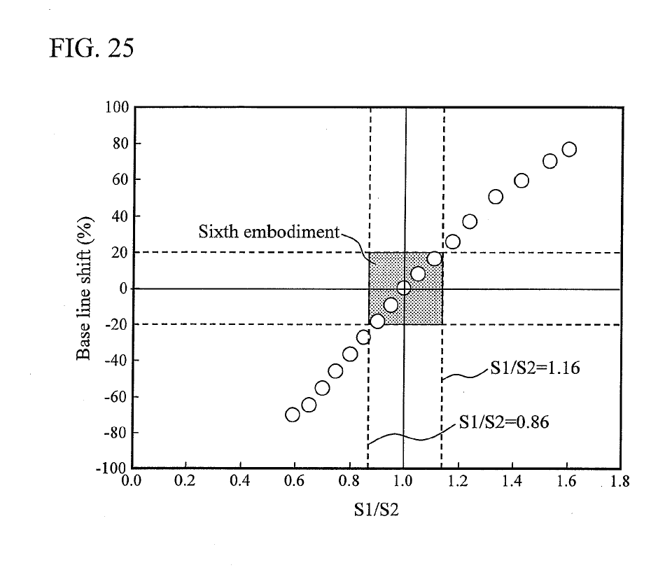

The present invention's structure can always reduce the size of the base line shift to within 20%, and thus can suppress the deterioration amount of the bit error rate to at most 10^{-0.8} or less. It is a preferred range as the magnetic recording apparatus that the size of the line shift is within 20%. FIG. 24 illustrates the condition of DR₁/DR₂ and HB₁/HB₂ that can suppress the size of the base line shift to within 20%.

The condition illustrated in FIG. 24 can be expressed by the following expression (10).

0.86×(DR₁/DR₂)<(HB₁/HB₂)<1.15×(DR₁/DR₂) (10)

Note that in the present configuration example, like the first embodiment or the third embodiment, DR₁/DR₂ is equal to or greater than 1.05 and equal to or less than 5.0 and Ms₁t₁/Ms₂t₂ is equal to or greater than 0.25 and equal to or less than 4.0. The reason for this is the same as described in the first embodiment, and thus the description is omitted.

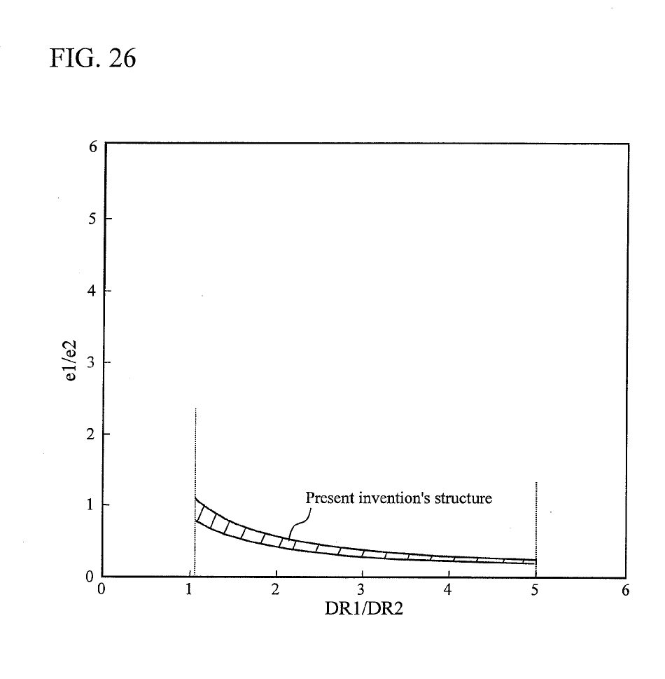

The reason why the size of the base line shift can be reduced to within 20% by satisfying the expression (10) will be described below. FIG. 25 illustrates the relation between S ₁/S₂ and the base line shift. As understood from FIG. 25, in order to reduce the size of the base line shift to within 20%, S ₁/S₂ needs to be equal to or greater than 0.86 and equal to or less than 1.15. Next, FIG. 26 illustrates a range between DR₁/DR₂ and e₁/e₂ for reducing the size of the base line shift to within 20%. This range can be easily determined by the expression (1) and the condition of S₁/S₂ for reducing the size of the base line shift to within 20% as described above. Finally, from the expression (5), HB₁/HB₂ is in reverse proportion to e₁/e₂, and thus the condition expressed by the expression (10) can be obtained.

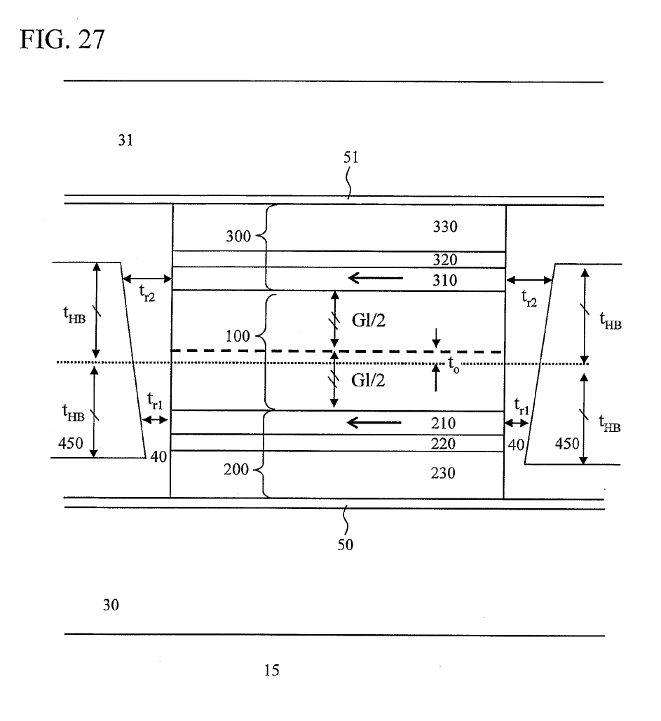

Next, a specific positional relation between the magnetic domain control layer 450 and the first and second free layers for satisfying the expression (10) will be described. FIG. 27 illustrates a differential read head according to the present configuration example. In FIG. 27, assuming that the distance between the first free layer and the second free layer is G₁, the film thickness of the magnetic domain control layer 450 is t_{HB}, each film thickness of the nonmagnetic intermediate layer 40 interposed between the magnetic domain control layer 450 and the first and second free layers is tᵣ₁ and tᵣ₂, and the distance between the center between the first free layer and the second free layer and the center of the magnetic domain control layer 450 in the film thickness direction is t₀, the following expression (11) is satisfied.

1.7×(DR₁/DR₂)<a tan α/a tan β+1<2.3×(DR₁/DR₂)

a tan α={a tan((t_{HB}/2+tₒ−G₁/2)/tᵣ₁)+a tan((t_{HB}/2−tₒ+G₁/2)/tᵣ₁)}

a tan β={a tan((t_{HB}/2+tₒ+G₁/2)/tᵣ₂)+a tan((t_{HB}/2−tₒ−G₁/2)/tᵣ₂)} (11)

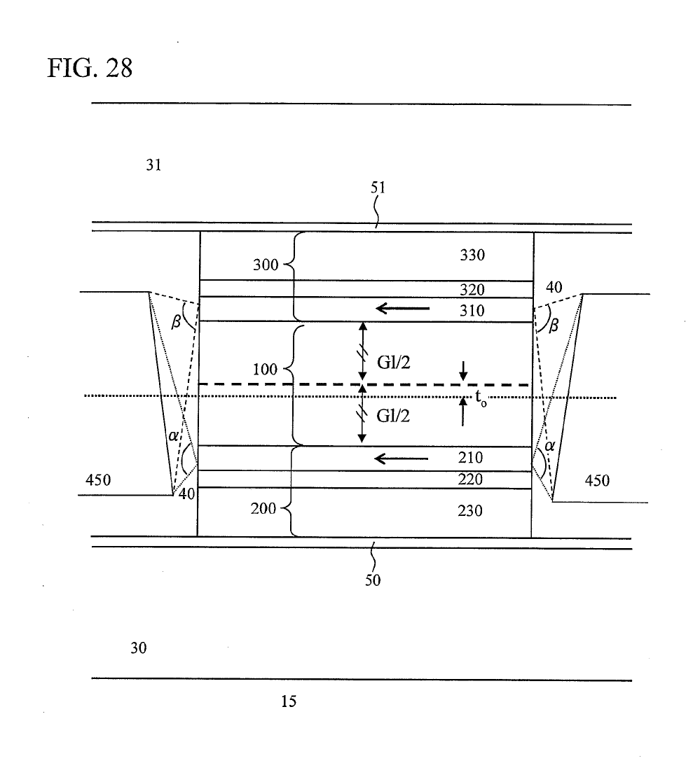

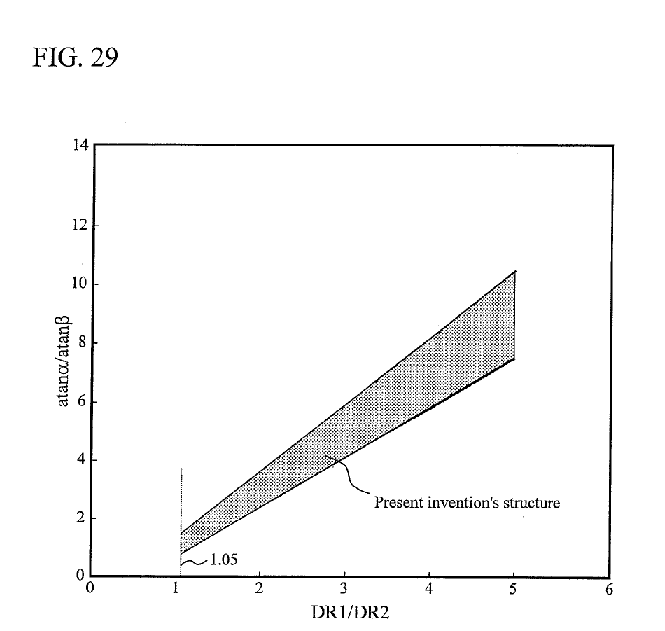

Here, as illustrated in FIG. 28, a is an angle formed by a lower end in the film thickness direction close to an end portion in the track width direction of the laminated film 400 in the magnetic domain control layer 450, the center point of the film thickness direction of the first free layer, and an upper end in the film thickness direction close to an end portion in the track width direction of the laminated film 400 in the magnetic domain control layer 450. Likewise, β is an angle formed by the center point in the film thickness direction of the second free layer and an upper end in the film thickness direction close to an end portion in the track width direction of the laminated film 400 in the magnetic domain control layer 450. Likewise HB₂ is an angle formed by the first and second free layers and the magnetic domain control film in proportion to β and the upper and lower end portions in the film thickness direction of the magnetic domain control film. The range of a tan α/a tan β according to DR₁/DR₂ derived from the expression (11) is as illustrated in FIG. 29.

The expression (11) can be easily derived by solving the simple simultaneous equations of the expression (12) and the expression (10).

HB₁/HB₂=0.5×a tan α/a tan β+0.5 (12)

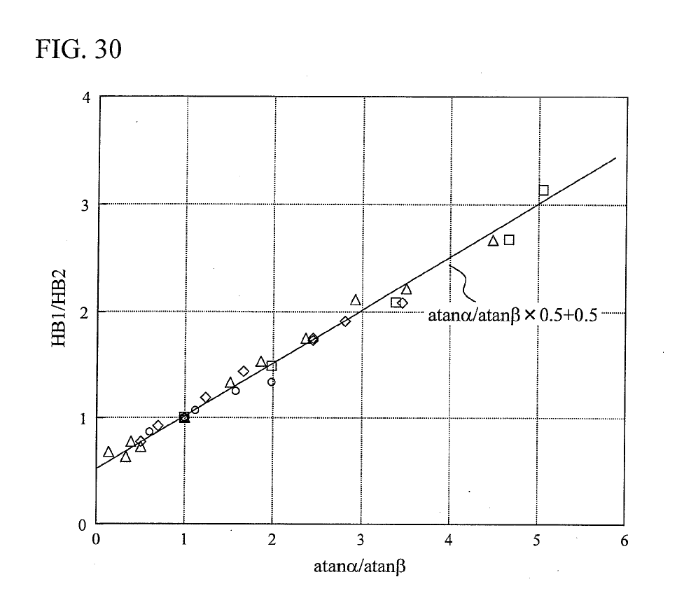

Here, HB₁/HB₂ is derived by calculating a large number of magnetic domain control fields of different shaped magnetic domain control films by finite element method and the calculated results are illustrated in FIG. 30. As understood from FIG. 30, the relation between HB₁/HB₂ and a tan α/a tan β satisfies the expression (12). The relation expressed by the expression (12) is true regardless of the rack width of the read head, the sensor height, the film thickness of the free layer, the shield interval, and the like.

The reason why HB₁/HB₂ is in proportion to a tan α/a tan β will be described using FIG. 28. When the center of the magnetic domain control layer 450 is located closer to the first free layer than to the second free layer, the magnetic domain control field HB₁ applied to the first free layer is in proportion to the angle α. Likewise, HB₂ is in proportion to β. The reason why the magnetic domain control field is in proportion to the angle formed by a magnetic body close thereto is disclosed in Non Patent Document 1.

In the configuration example illustrated in FIG. 27 according to the present invention, specifically, DR₁ is 200Ω, DR₂ is 133Ω; tᵣ₁ and tᵣ₂ are 5 nm and 10 nm respectively; tₒ is 5 nm; the center of the magnetic domain control layer 450 is closer to the first free layer than to the second free layer; and t_{HB} is 40 nm and G₁ is 20 nm. HB ₁ and HB₂ are 2100 Oe and 1400 Oe respectively; and e₁ and e₂ are 18% and 27% respectively. Accordingly, S₁/S₂ is 1.0 and thus, almost no base line shift occurs. The present configuration example is just an example. The size relation between tᵣ₁ and tᵣ₂, the offset direction of the magnetic domain control layer 450, and the offset amount thereof may be different from those of the present configuration example as long as the range satisfies the expression (11).

### Sixth Embodiment

Another configuration example of the present invention will be described. The present configuration example is used when DR₁ is smaller than DR₂. Like the configuration of the fifth embodiment, the present configuration example reduces the base line shift caused by the difference between DR₁ and DR₂ to within 20% by controlling HB₁ and HB₂. The present configuration example is the same as the configuration of the fifth embodiment except the positional relation between the magnetic domain control film and the magneto-resistive film, and thus the detailed description of the configuration is omitted.

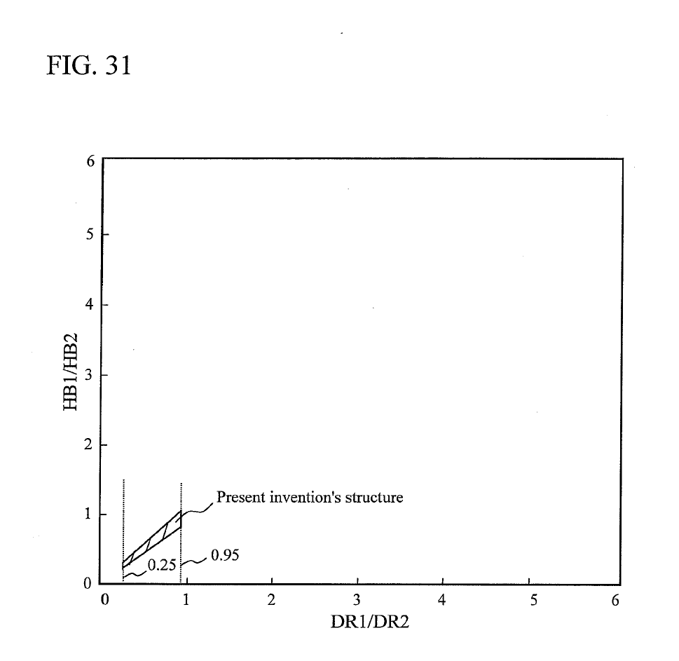

FIG. 31 illustrates the conditions for DR₁/DR₂ and HB₁/HB₂ for suppressing the size of the base line shift to within 20%. Like the fifth embodiment, this is derived from the expression (10).

Like the second embodiment or the fourth embodiment, DR₁/DR₂ is equal to or greater than 0.25 and equal to or less than 0.95 and Ms ₁t₁/Ms₂t₂ is equal to or greater than 0.25 and equal to or less than 4.0.

Next, a specific positional relation between the magnetic domain control layer 450 and the first and second free layers for satisfying the expression (10) will be described. When the center of the magnetic domain control layer 450 is located closer to the second free layer than to the first free layer, the present configuration example is configured to satisfy the expression (13).

1.7×(DR₂/DR₁)<a tan α/a tan β+1<2.3×(DR₂/DR₁)

a tan α={a tan((t_{HB}/2+tₒ−G₁/2)/tᵣ₂)+a tan((t_{HB}/2−tₒ+G₁/2)/tᵣ₂)}

a tan β={a tan((t_{HB}/2+tₒ+G₁/2)/tᵣ₁)+a tan((t_{HB}/2−tₒ−G₁/2)/tᵣ₁)} (13)

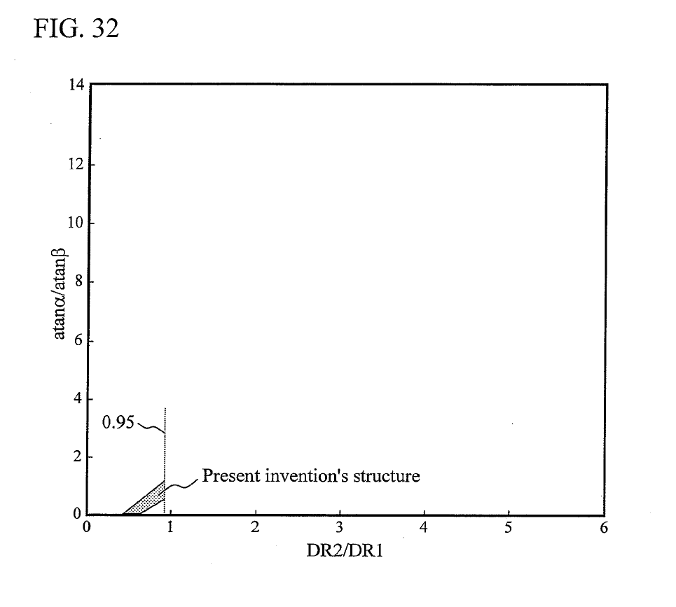

Like the fifth embodiment, the range of a tan α/a tan β according to DR₁/DR₂ derived from the expression (13) is as illustrated in FIG. 32. Even if the differential read head is such that DR₁ is smaller than DR₂, the present configuration example can achieve a differential read head which reduces the base line shift to within 20% and exhibits a good bit error rate.

### Seventh Embodiment

Another configuration example of the present invention will be described below. The present embodiment is different from the configuration of the first embodiment only in the range of Ms₁t₁/Ms₂t₂. Therefore, DR₁/DR₂ is assumed to be equal to or greater than 1.05 and equal to or less than 4.0. Here, the description other than the configuration of the first and second free layers regarding Ms₁t₁/Ms₂t₂ is omitted. The present configuration is used when Ms₁t₁/Ms₂t₂ is larger than 4.0 or smaller than 0.25 in FIGS. 9 and 10. The present embodiment is characterized by adjusting the positional relation between the first and second free layers and the magnetic domain control layer 450 by considering the difference of the utilization caused by a large difference in Mst of the first and second free layers. Specifically, the differential read head is controlled as follows.

Control is made in such a manner that when Ms₁t₁/Ms₂t₂ is equal to or greater than 4.0, the following expression (14) is satisfied and when Ms₁t₁/Ms₂t₂ is less than 0.25, the expression (15) is satisfied.

0.86×(DR₁/DR₂)<(HB₁/HB₂)×1/(0.003×((Ms₁t₁)/(Ms₂t₂))²+0.997)<1.15×(DR₁/DR₂) (14)

0.86×(DR₂/DR₁)<(HB₂/HB₁)×1/(0.003×((Ms₂t₂)/(Ms₁t₁))²+0.997)<1.15×(DR₂/DR₁) (15)

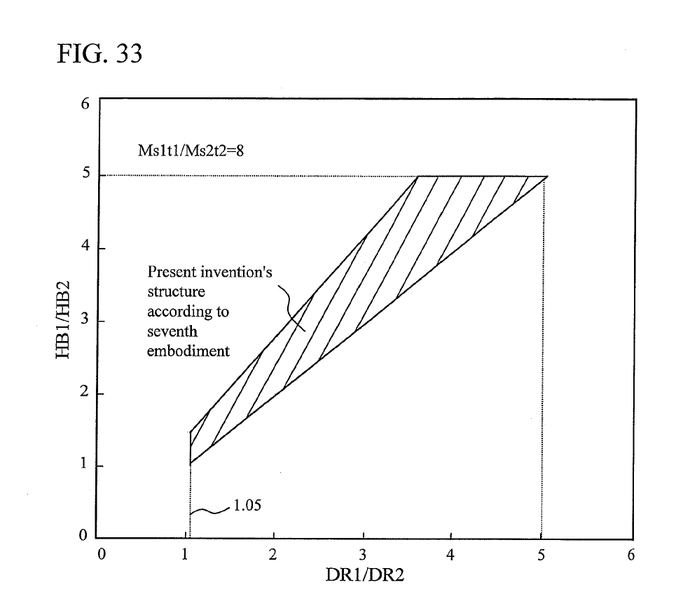

As the present configuration example, FIG. 33 illustrates a range of HB₁/HB₂ according to DR₁/DR₂ when (Ms₁t₁)/(Ms₂t₂) is 8.0. As a configuration example of (Ms₁t₁) and (Ms₂t₂), for example, Ms₁ is 15000 Oe and t₁ is 4 nm; and Ms₂ is 10000 Oe and t₂ is 0.75 nm. In the present configuration example, (Ms₁t₁)/(Ms₂t₂) is 8.0, but any value may be used as long as the value is equal to or greater than 4.0 or less than 0.25. Thus, the present configuration example can reduce the base line shift to within 20% by controlling HB₁/HB₂ according to DR₁/DR₂.

### Eighth Embodiment

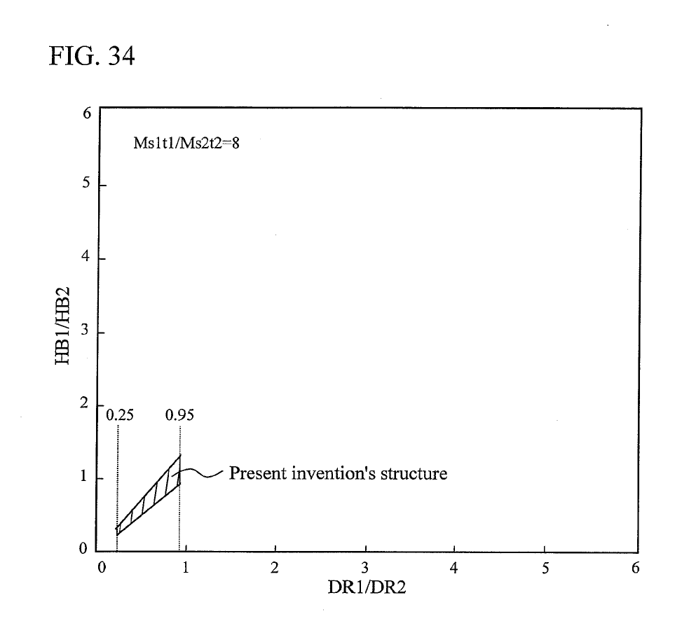

Another embodiment of the present invention will be described below. The present embodiment is different in configuration from the seventh embodiment only in that the range of DR₁/DR₂ is equal to or greater than 0.25 and equal to or less than 0.95. Here, the description other than the configuration of the first and second free layers regarding Ms₁t₁/Ms₂t₂ is omitted. Like the seventh embodiment, the present configuration example controls such that when Ms₁t₁/Ms₂t₂ is equal to or greater than 4.0, the expression (14) is satisfied, and when Ms₁t₁/Ms₂t₂ is less than 0.25, the expression (15) is satisfied. As the present configuration example, FIG. 34 illustrates a range of HB₁/HB₂ according to DR₁/DR₂ when (Ms₁t₁)/(Ms₂t₂) is 8.0. Thus, the present configuration example can suppress the base line shift caused by the difference between DR₁ and DR₂ to within 20% by controlling HB₂/HB₁ according to Ms₁t₁/Ms₂t₂.

### Ninth Embodiment

Another embodiment of the present invention will be described below. The present embodiment is different in configuration from the first embodiment only in that the saturation magnetization is different between a region contacting the first free layer of the magnetic domain control layer 450 and a region contacting the second free layer thereof. Here, the description other than the configuration regarding the saturation magnetization of the magnetic domain control layer 450 is omitted. In order to control HB₁/HB₂, the present configuration example controls MsHB₁/MsHB₂ which is a ratio between the saturation magnetization MsHB₁ of the magnetic domain control layer 450 of a region close to the first free layer and the saturation magnetization MsHB₂ of the magnetic domain control layer 450 of a region close to the second free layer. More specifically, the differential read head is configured so as to satisfy the following expression (16).

0.86×(DR₁/DR₂)<(MsHB₁/MsHB₂)<1.15×(DR₁/DR₂) (16)

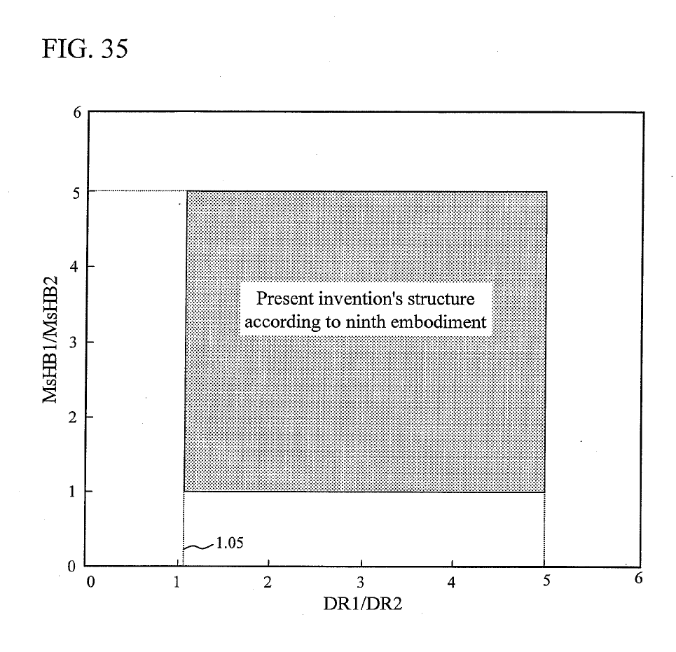

FIG. 35 illustrates a range between DR₁/DR₂ and MsHB₁/MsHB₂ in the present configuration example. The reason why the range between DR₁/DR₂ and MsHB₁/MsHB₂ should be adjusted to this range is that the magnetic domain control field applied to the first free layer and the second free layer increases with the saturation magnetization of the magnetic domain control layer 450 of a region close to each free layer. Accordingly, HB₁/HB₂ can be controlled by changing MsHB₁/MsHB₂ according to DR₁/DR₂. Thus, the base line shift can be reduced.

Next, a specific control method for MsHB₁ and MsHB₂ will be described. The easiest method of controlling MsHB₁ and MsHB₂ independently is to change the material of the magnetic domain control layer 450 of a region close to the individual magneto-resistive sensors. This is because the saturation magnetization of the magnetic domain control layer 450 depends greatly on the material thereof. Example materials for the magnetic domain control layer 450 include CoCrPt alloy thin film (about 1000 gausses), Fe—Cr—Co alloy (about 13000 gausses), PtCo alloy (about 7000 gausses), and Sm—Co alloy (about 8000 to 10000 gausses).

Any material can be selected from the above typical magnetic materials so as to satisfy the expression (16). The control method for the saturation magnetization of the magnetic domain control layer 450 may include another method of controlling film formation conditions. Any control method for the saturation magnetization may be used as long as the control method is not regarded as a departure from the spirit and scope of the present invention. For example, the method of controlling the film formation conditions includes a method of increasing only the saturation magnetization of the lower magnetic domain control layer 450 by performing thermal treatment only before film formation of the upper film of the magnetic domain control layer 450; and a method of controlling the saturation magnetization by changing the underlying layer of the lower and upper magnetic domain control layers 450.

### Tenth Embodiment

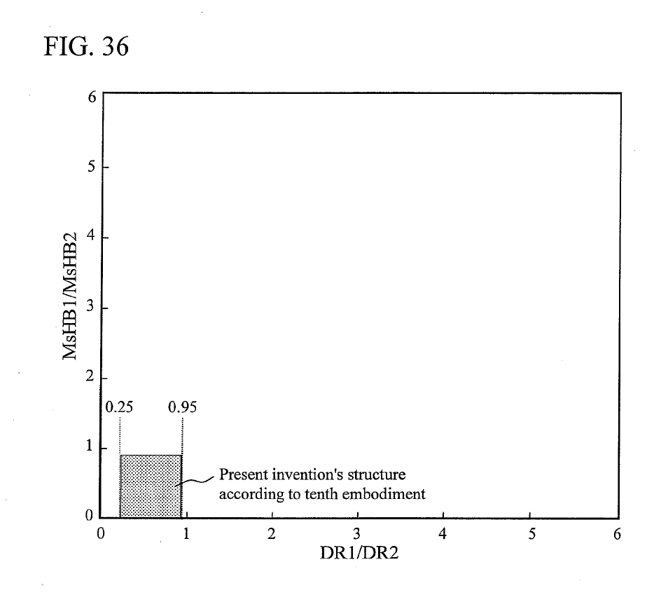

Another embodiment of the present invention will be described below. The present embodiment is different in configuration from the ninth embodiment only in that the range of DR₁/DR₂ is equal to or greater than 0.25 and equal to or less than 0.95. Like the ninth embodiment, the present configuration example controls so as to satisfy the expression (16). FIG. 36 illustrates a range between DR₁/DR₂ and MsHB₁/MsHB₂ based on the expression (16). The specific method of controlling MsHB₁ and MsHB₂ independently is the same as that of the ninth embodiment and the description thereof is omitted. Even if DR₁ is smaller than DR₂, the present configuration can suppress the base line shift to within 20% by controlling the saturation magnetization of the magnetic domain control film.

### Eleventh Embodiment

Another configuration example of the present invention will be described below. The present embodiment is different from the configuration of the first embodiment only in that the current conducting direction is not a direction perpendicular to the surface of the laminated film 400, but the in-plane direction of the laminated film 400. Here, the description other than the current conducting direction is omitted.

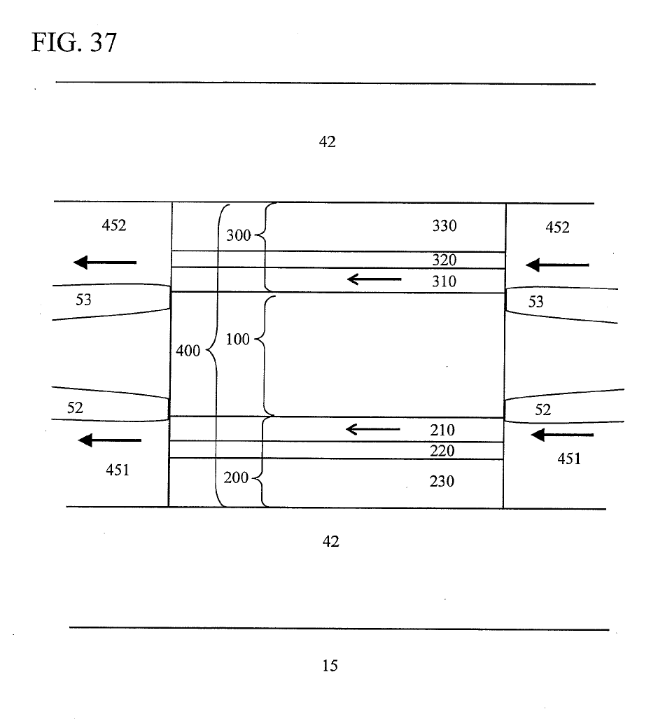

A typical configuration example according to the present invention is illustrated in FIG. 37. In order to set the current conducting direction to the in-plane direction of the laminated film 400, the present configuration example provides two pairs of electrodes (52: first electrode and 53: second electrode) so as to contact both sides in the track width direction of the individual magneto-resistive sensors (200 and 300). Regarding the magnetic domain control layer, two layers, a first magnetic domain control layer 451 and a second magnetic domain control layer 452, need to be provided so as to be close to the first magneto-resistive sensor 200 and the second magneto-resistive sensor 300. In principle, the differential read head which has two pairs of electrodes 52 and 53 and conducts current in the in-plane direction of the laminated film 400 can control the size of the current conducting in the two magneto-resistive sensors independently by providing two pairs of electrodes. However, there is a problem in that an independent control of the current amount of the individual magneto-resistive sensors requires a complicated control circuit other than the read head such as a preamplifier circuit. Even if the size of current conducting in individual magneto-resistive sensors is equal, the present configuration example can achieve a differential read head capable of suppressing the base line shift. Specifically, the same configuration as described in the first embodiment is used as described below.

According to DR₁/DR₂ which is a ratio between DR₁ and DR₂, HB₁/HB₂ which is a ratio between the magnetic domain control field HB₁ applied to the first magneto-resistive sensor 200 and the magnetic domain control field HB₂ applied to the second magneto-resistive sensor 300 is configured to satisfy the expression (2) or the expression (5). Note that it is assumed that Ms ₁t₁/Ms₂t₂ which is a ratio between the product Ms₁t₁ of the saturation magnetization Ms₁ of the first free layer and the film thickness t₁ and the product Ms₂t₂ of the saturation magnetization Ms₂ of the second free layer and the film thickness t₂ is equal to or greater than 0.25 and equal to or less than 4.0. Even if the individual magneto-resistive sensors have a different DR, the differential read head of the present configuration example can reduce the size of the base line shift and can suppress the deterioration of the bit error rate.

### Description of Symbols

15 Substrate
30 Lower magnetic shield
31 Upper magnetic shield
40 Nonmagnetic intermediate layer
50 Lower electrode
51 Upper electrode
52 First electrode
53 Second electrode
61 Main pole
62 Wraparound shield
63 Coil
64 Return pole
71 Underlying layer
72 Upper magnetic shield underlying layer
75 Protection film
81 ABS surface
90 Head slider
91 Disk
92 Actuator
100 Differential gap layer
200 First magneto-resistive sensor
210 First free layer
220 First intermediate layer
230 First reference layer
236 First antiferromagnetic layer
300 Second magneto-resistive sensor
310 Second free layer
320 Second intermediate layer
330 Second reference layer
334 Second antiferromagnetic layer

1. (canceled)

2. A read head comprising: a first magneto-resistive sensor interposing a first intermediate layer between a first free layer and a first reference layer; a second magneto-resistive sensor interposing a second intermediate layer between a second free layer and a second reference layer; a differential gap layer interposed between the first magneto-resistive sensor and the second magneto-resistive sensor; and a current application means for applying current to the first magneto-resistive sensor and the second magneto-resistive sensor, the first magneto-resistive sensor and the second magneto-resistive sensor having an opposite phase resistance to same direction fields and performing differential operation,
the read head further comprising a magnetic domain control layer wherein
assuming that a product of a saturation magnetization of the first free layer and a film thickness thereof is set to Ms₁t₁ and a product of a saturation magnetization of the second free layer and a film thickness thereof is set to Ms₂t₂, Ms₁t₁/Ms₂t₂ is equal to or greater than 0.25 and equal to or less than 4.0, and
assuming that a maximum resistance change of the first magneto-resistive sensor is set to DR₁, a maximum resistance change of the second magneto-resistive sensor is set to DR₂, a magnetic domain control field applied to the first free layer is set to HB₁, and a magnetic domain control field applied to the second free layer is set to HB₂, when DR₁/DR₂ is equal to or greater than 1.05, HB₁>HB₂ is true,
wherein an output of the first magneto-resistive sensor is substantially equal to an output of the second magneto-resistive sensor.

3. A read head comprising: a first magneto-resistive sensor interposing a first intermediate layer between a first free layer and a first reference layer; a second magneto-resistive sensor interposing a second intermediate layer between a second free layer and a second reference layer; a differential gap layer interposed between the first magneto-resistive sensor and the second magneto-resistive sensor; and a current application means for applying current to the first magneto-resistive sensor and the second magneto-resistive sensor, the first magneto-resistive sensor and the second magneto-resistive sensor having an opposite phase resistance to same direction fields and performing differential operation,
the read head further comprising a magnetic domain control layer wherein
assuming that a product of a saturation magnetization of the first free layer and a film thickness thereof is set to Ms₁t₁ and a product of a saturation magnetization of the second free layer and a film thickness thereof is set to Ms₂t₂, Ms₁t₁/Ms₂t₂ is equal to or greater than 0.25 and equal to or less than 4.0, and
assuming that a maximum resistance change of the first magneto-resistive sensor is set to DR₁, a maximum resistance change of the second magneto-resistive sensor is set to DR₂, a magnetic domain control field applied to the first free layer is set to HB₁, and a magnetic domain control field applied to the second free layer is set to HB₂, when DR₁/DR₂ is equal to or greater than 0.95, HB₁>HB₂ is true,
wherein an output of the first magneto-resistive sensor is substantially equal to an output of the second magneto-resistive sensor.

4. The read head according to claim 2, wherein assuming that a shortest distance between a center in a film thickness direction of an end portion in a track width direction of the first free layer and a magnetic domain control layer close to the first free layer is set to D₁, and a shortest distance between a center in a film thickness direction of an end portion in a track width direction of the second free layer and a magnetic domain control layer close to the first free layer is set to D₂, D₁<D₂ is true.

5. The read head according to claim 3, wherein assuming that a shortest distance between a center in a film thickness direction of an end portion in a track width direction of the first free layer and a magnetic domain control layer close to the first free layer is set to D₁, and a shortest distance between a center in a film thickness direction of an end portion in a track width direction of the second free layer and a magnetic domain control layer close to the first free layer is set to D₂, D₁>D₂ is true.

6. The read head according to claim 2, wherein assuming that a film thickness of a nonmagnetic intermediate layer interposed between the magnetic domain control layer and the first free layer is set to tᵣ₁ and a film thickness of a nonmagnetic intermediate layer interposed between the magnetic domain control layer and the second free layer is set to tᵣ₂, tᵣ₁<tᵣ₂ is true.

7. The read head according to claim 3, wherein assuming that a film thickness of a nonmagnetic intermediate layer interposed between the magnetic domain control layer and the first free layer is set to tᵣ₁ and a film thickness of a nonmagnetic intermediate layer interposed between the magnetic domain control layer and the second free layer is set to tᵣ₂, tᵣ₁>tᵣ₂ is true.

8. The read head according to claim 2, wherein HB₁/HB₂ which is a ratio between a magnetic domain control field applied to the first free layer and a magnetic domain control field applied to the second free layer and DR₁/DR₂ which is a ratio between a maximum resistance change DR₁ of the first magneto-resistive sensor and a maximum resistance change DR₂ of the second magneto-resistive sensor satisfy
0.86×(DR₁/DR₂)<(HB₁/HB₂)<1.15×(DR₁/DR₂).

9. The read head according to claim 2, further comprising a magnetic domain control layer provided on both sides in a track width direction of at least one of the first free layer and the second free layer,
wherein assuming that a distance between the first free layer and the second free layer is set to G₁, a film thickness of the magnetic domain control layer is set to to, a film thickness of a nonmagnetic intermediate layer interposed between the magnetic domain control layer and the first free layer is set to tᵣ₁, a film thickness of a nonmagnetic intermediate layer interposed between the magnetic domain control layer and the second free layer is set to tᵣ₂, and a distance between a center between the first free layer and the second free layer and a center of the magnetic domain control layer is set to tₒ, when the center of the magnetic domain control layer is closer to the first free layer than to the second free layer,
1.7×(DR₁/DR₂)<{a tan((t_{HB}/2+tₒ−G₁/2)/tᵣ₁)+a tan((t_{HB}/2−tₒ+G₁/2)/tᵣ₁)}/{a tan((t_{HB}/2+tₒ+G₁/2)/tᵣ₂)+a tan((t_{HB}/2−tₒ−G₁/2)/tᵣ₂)}+1<2.3×(DR₁/DR₂) is satisfied.

10. The read head according to claim 2, further comprising a magnetic domain control layer provided on both sides in a track width direction of at least one of the first free layer and the second free layer,
wherein assuming that a distance between the first free layer and the second free layer is set to G₁, a film thickness of the magnetic domain control layer is set to t_{HB}, a film thickness of a nonmagnetic intermediate layer interposed between the magnetic domain control layer and the first free layer is set to tᵣ₁, a film thickness of a nonmagnetic intermediate layer interposed between the magnetic domain control layer and the second free layer is set to tᵣ₂, and a distance between a center between the first free layer and the second free layer and a center of the magnetic domain control layer is set to tₒ, when the center of the magnetic domain control layer is closer to the second free layer than to the first free layer,
1.7×(DR₂/DR₁)<{a tan((t_{HB}/2+tₒ−G₁/2)/tᵣ₂)+a tan((t_{HB}/2−tₒ+G₁/2)/tᵣ₂)}/{a tan((t_{HB}/2+tₒ+G₁/2)/tᵣ₁)+a tan((t_{HB}/2−tₒ−G₁/2)/tᵣ₁)}+1<2.3×(DR₂/DR₁) is satisfied.

11. The read head according to claim 2, further comprising a magnetic domain control layer provided on both sides in a track width direction of at least one of the first free layer and the second free layer,
wherein assuming that a saturation magnetization of a region close to the first free layer is set to MsHB₁, and a saturation magnetization of a region close to the second free layer is set to MsHB₂, the magnetic domain control layer provided on both sides in the track width direction of the laminated structure satisfies
0.86×(DR₁/DR₂)<(MsHB₁/MsHB₂)<1.15×(DR₁/DR₂).

12. The read head according to claim 2, wherein
the current application means
conducts current in a direction substantially perpendicular to film surfaces of the first magneto-resistive sensor, the second magneto-resistive sensor, and the differential gap layer, and
is a pair of electrodes formed on a surface opposite to a surface facing the differential gap layer of the first magneto-resistive sensor and on a surface opposite to a surface facing the differential gap layer of the second magneto-resistive sensor.

13. The read head according to claim 2, wherein
the current application means
conducts current independently in a film surface direction of the first magneto-resistive sensor and the second magneto-resistive sensor, and
is two pairs of electrodes provided on both sides of the first magneto-resistive sensor and the second magneto-resistive sensor.

14. The read head according to claim 3, wherein HB₁/HB₂ which is a ratio between a magnetic domain control field applied to the first free layer and a magnetic domain control field applied to the second free layer and DR₁/DR₂ which is a ratio between a maximum resistance change DR₁ of the first magneto-resistive sensor and a maximum resistance change DR₂ of the second magneto-resistive sensor satisfy
0.86×(DR₁/DR₂)<(HB₁/HB₂)<1.15×(DR₁/DR₂).

15. The read head according to claim 3, further comprising a magnetic domain control layer provided on both sides in a track width direction of at least one of the first free layer and the second free layer,
wherein assuming that a distance between the first free layer and the second free layer is set to G₁, a film thickness of the magnetic domain control layer is set to t_{HB}, a film thickness of a nonmagnetic intermediate layer interposed between the magnetic domain control layer and the first free layer is set to tᵣ₁, a film thickness of a nonmagnetic intermediate layer interposed between the magnetic domain control layer and the second free layer is set to tᵣ₂, and a distance between a center between the first free layer and the second free layer and a center of the magnetic domain control layer is set to tₒ, when the center of the magnetic domain control layer is closer to the first free layer than to the second free layer,
1.7×(DR₁/DR₂)<{a tan((t_{HB}/2+tₒ−G₁/2)/tᵣ₁)+a tan((t_{HB}/2−tₒ+G₁/2)/tᵣ₁)}/{a tan((t_{HB}/2+tₒ+G₁/2)/tᵣ₂)+a tan((t_{HB}/2−tₒ−G₁/2)/tᵣ₂)}+1<2.3×(DR₁/DR₂) is satisfied.

16. The read head according to claim 3, further comprising a magnetic domain control layer provided on both sides in a track width direction of at least one of the first free layer and the second free layer,
wherein assuming that a distance between the first free layer and the second free layer is set to G₁, a film thickness of the magnetic domain control layer is set to t_{HB}, a film thickness of a nonmagnetic intermediate layer interposed between the magnetic domain control layer and the first free layer is set to tᵣ₁, a film thickness of a nonmagnetic intermediate layer interposed between the magnetic domain control layer and the second free layer is set to tᵣ₂, and a distance between a center between the first free layer and the second free layer and a center of the magnetic domain control layer is set to tₒ, when the center of the magnetic domain control layer is closer to the second free layer than to the first free layer,
1.7×(DR₂/DR₁)<{a tan((t_{HB}/2+tₒ−G₁/2)/tᵣ₂)+a tan((t_{HB}/2−tₒ+G₁/2)/tᵣ₂)}/{a tan((t_{HB}/2+tₒ+G₁/2)/tᵣ₁)+a tan((t_{HB}/2−tₒ−G₁/2)/tᵣ₁)}+1<2.3×(DR₂/DR₁) is satisfied.

17. The read head according to claim 3, further comprising a magnetic domain control layer provided on both sides in a track width direction of at least one of the first free layer and the second free layer,
wherein assuming that a saturation magnetization of a region close to the first free layer is set to MsHB₁, and a saturation magnetization of a region close to the second free layer is set to MsHB₂, the magnetic domain control layer provided on both sides in the track width direction of the laminated structure satisfies
0.86×(DR₁/DR₂)<(MsHB₁/MsHB₂)<1.15×(DR₁/DR₂).

18. The read head according to claim 3, wherein
the current application means
conducts current in a direction substantially perpendicular to film surfaces of the first magneto-resistive sensor, the second magneto-resistive sensor, and the differential gap layer, and
is a pair of electrodes formed on a surface opposite to a surface facing the differential gap layer of the first magneto-resistive sensor and on a surface opposite to a surface facing the differential gap layer of the second magneto-resistive sensor.

19. The read head according to claim 3, wherein
the current application means
conducts current independently in a film surface direction of the first magneto-resistive sensor and the second magneto-resistive sensor, and
is two pairs of electrodes provided on both sides of the first magneto-resistive sensor and the second magneto-resistive sensor.
